(19) United States
(12) Patent Application Publication
(10) Pub. No.: US 2026/0259091 A1
(43) Pub. Date: Sep. 3, 2026

(54) REACTION-TYPE TORQUE CELLS

(71) Applicant: Figure AI Inc., San Jose, CA (US)

(72) Inventors: Jacob Daniel Webb, San Jose, CA (US); Keith Wakeham, San Jose, CA (US); Steven Culver, San Jose, CA (US)

(21) Appl. No.: 19/655,269

(22) Filed: Apr. 22, 2026

Related U.S. Application Data
(63) Continuation of application No. 18/922,334, filed on Oct. 21, 2024.
(60) Provisional application No. 63/693,025, filed on Sep. 10, 2024.
(60) Provisional application No. 63/676,722, filed on Jul. 29, 2024.
(60) Provisional application No. 63/595,695, filed on Nov. 2, 2023.
(60) Provisional application No. 63/591,507, filed on Oct. 19, 2023.

(51) Int. Cl. G01L 3/10; G01L 5/00; G01L 5/1627; B25J 13/08

(52) U.S. Cl. CPC G01L 3/108; G01L 5/0061; G01L 5/1627; B25J 13/085

(57) ABSTRACT

Various embodiments of a torque cell including a flexure element and sensor assembly are disclosed. A flexure element includes an inner ring, an outer ring, and a plurality of beams arranged symmetrically and extending radially connecting the inner ring to the outer ring. Each beam has a first surface, a second surface, and a recessed portion. The recessed portion having a recessed surface recessed from the first surface of the beam with an extent of the recessed surface of the recessed portion having a planar gauge portion that is substantially parallel with a plane perpendicular to a central axis of the flexure element. Each planar gauge portion of the plurality of beams are in the same plane. The sensor assembly including a plurality of strain gauges affixed to the beams within the planar gauge portion and a measurement circuit coupled to the plurality of strain gauges.

### CROSS-REFERENCE TO RELATED APPLICATIONS

This application is a continuation of U.S. Patent Application No. 18/922,334, filed October 21, 2024, which claims the benefit of and priority to U.S. Provisional Patent Application No’s. 63/591,507, filed October 19, 2023, 63/595,695, filed November 2, 2023, 63/676,722, filed July 29, 2024, and 63/693,025, filed September 10, 2024, each of which is expressly incorporated by reference herein in its entirety.

Reference is hereby made to: (i) U.S. Patent Application Nos. 18/919,263, 18/914,800, and 18/904,332; (ii) U.S. Design Patent Application Nos. 29/935,680, 29/928,748, and 29/889,764; and (iii) U.S. Provisional Patent Application Nos. 63/626,035, 63/564,741, 63/626,034, 63/626,037, 63/626,030, 63/626,028, 63/634,697, 63/707,949, 63/707,897, 63/707,547, 63/708,003, 63/557,874, 63/626,040, 63/626,105, 63/625,362, 63/625,370, 63/625,381, 63/625,384, 63/625,389, 63/625,405, 63/625,423, 63/625,431, 63/685,856, 63/696,507, and 63/696,533, each of which is expressly incorporated by reference herein in its entirety.

### TECHNICAL FIELD

This disclosure relates to a torque cell of an actuator in a humanoid robot. In particular, the following discusses a reaction-type torque cell of a rotary actuator that is used in conjunction with a general-purpose humanoid robot, wherein the reaction-type torque cell measures torques that a computer contained in said general-purpose humanoid robot may utilize to control the output of an actuator.

### BACKGROUND

The contemporary workplace is facing an unprecedented labor shortage, with over 10 million jobs in the United States classified as unsafe, undesirable, or unfilled. This shortage spans a wide range of industries, including manufacturing (e.g., car manufacturing), construction, and logistics (e.g., sorting and delivering packages), where tasks often involve repetitive, strenuous, and/or hazardous activities unattractive to the human workforce. This deficit hampers productivity and poses significant challenges to economic growth and workplace safety. To address this escalating issue, it has become imperative to design and integrate advanced robotic systems capable of performing these unappealing and potentially dangerous tasks. To execute these tasks optimally and efficiently, the disclosed general-purpose humanoid robot was developed.

The execution of these tasks by the general-purpose humanoid robot hinges on the accurate measurement and control of torque in its joints and limbs. Conventional torque measurement methods involving direct contact with rotating components introduce several challenges. For example, said conventional torque measurement methods may add mechanical complexities such as slip rings or additional wiring, which may compromise the humanoid robot's design and functionality. Moreover, these conventional methods are prone to inaccuracies caused by friction, backlash, and mechanical wear, leading to degraded performance over time and increased maintenance requirements. Therefore, there exists a need for an improved torque measurement solution that overcomes these limitations.

The disclosed reaction-type torque cell addresses these issues and other issues disclosed herein by measuring torque indirectly through the reaction forces exerted on the actuator housing. This non-intrusive measurement technique eliminates the need for components that interface directly with moving parts, thereby reducing mechanical disturbances and minimizing wear on the system. Additionally, the real-time feedback provided by the disclosed reaction-type torque cell: (i) allows for said robot to make precise adjustments to actuator operations, resulting in smoother movements, better responsiveness, and improved overall performance, and (ii) helps prevent actuator overloads, which safeguard against mechanical failures, and extend the operational lifespan of the humanoid robot. Thus, implementing a reaction-type torque cell is instrumental in advancing the capabilities and reliability of humanoid robots, ultimately contributing to the broader goal of integrating advanced robotics into the workforce to mitigate labor shortages and enhance workplace safety.

### SUMMARY OF THE INVENTION

A reaction-type torque cell installable in a humanoid robot includes a flexure element and a sensor assembly. The flexure element has an inner ring, an outer ring, and a plurality of beams arranged symmetrically and extending radially outward to connect the inner ring to the outer ring. Each beam has a first surface, a second surface, and a recessed or sunken portion with a recessed surface recessed from the first surface of the beam, and wherein an extent of said recessed surface has a planar gauge surface portion residing in a gauge plane that is substantially parallel with a reference plane oriented perpendicular to a central axis of the flexure element. The sensor assembly includes a plurality of strain gauges and a measurement circuit coupled to individual resistance gauge elements of the strain gauges. Each strain gauge has a first resistance gauge element and a second resistance gauge element. Each strain gauge is affixed to the planar gauge portion of the recessed surface of each beam such that the first resistance gauge element and the second resistance gauge element of the strain gauge are arranged symmetrically about a center midline of said beam. The reaction-type torque cell can also include a protective shield coupled to the inner ring and overlaying the second surface of the beams without contacting the beams.

In illustrative embodiments, each beam also includes a tapered section decreasing in thickness from the inner ring to the outer ring. The first surface of the tapered section is substantially parallel to the reference plane of the flexure element and the second surface of the tapered section is inclined at a taper angle relative to the first surface. Each radial beam includes a pair of support sections and a measurement section that resides between the support sections. The recessed or sunken portion of each radial beam at least partially defines the measurement section. A plurality of separation portions are located between the beams, each separation portion includes an opening that separates the inner ring from the outer ring and at least partially defines adjacent radial beams.

In some embodiments, the inner ring includes an inner mounting portion and an inner transition portion, the mounting portion formed around a central hub aperture about the central axis. The inner transition portion provides a transition from the inner mounting portion to the tapered section. The inner mounting portion can have a thickness greater than a maximum thickness of the beams and have an engagement extent that protrudes with respect to the second surface of the beams. In some embodiments, the engagement extent can include at least one slot or groove configured to interface with a protective shield. In other embodiments, the inner ring includes an inner mounting portion only, and the projection portion is omitted.

In illustrative embodiments, the flexure element is coupled to an actuator housing at the outer ring. In some embodiments, the flexure element is integrated into an actuator housing at the outer ring. The actuator housing and the flexure element can be formed in one piece. In other embodiments, the flexure element further includes an outer mounting portion adjacent to the outer ring and is configured to couple to an actuator housing by fasteners.

In illustrative embodiments, a flexure and sensor assembly of a torque cell installable in a humanoid robot includes a flexure element with a plurality of beams and a sensor assembly including (i) a plurality of strain gauges with a first resistance gauge element and a second resistance gauge element, and (ii) a measurement circuit coupled to the first and second resistance gauge elements. Each beam includes a planar gauge surface portion within a recessed surface of each beam of the flexure element. The first resistance gauge element and the second resistance gauge element are affixed symmetrically about a midline of one beam of a plurality of beams of the flexure element. The first and second resistance gauge elements include a pair of contacts, and the measurement circuit comprises a wiring arrangement to connect the resistance gauge elements in a Wheatstone bridge arrangement. The Wheatstone bridge arrangement includes a voltage source, a ground, a first signal connection, and a second signal connection, wherein a first half of the first resistance gauge elements are coupled between the voltage source and the first signal connection, and a second half of the first resistance gauge elements are coupled between the second signal connection and the ground, and a first half of the second resistance gauge elements are coupled between the voltage source and the second signal connection, and a second other half of the second resistance gauge elements are coupled between the first signal connection and the ground. The first resistance gauge element can have an active grid area arranged at -45 degrees and the second resistance gauge element has an active grid area arranged at +45 degrees.

In illustrative embodiments, the plurality of beams of the flexure element comprise four beams that are angularly arranged 90 degrees apart, whereby the center midlines intersect at the center axis of the flexure element, and wherein the plurality of strain gauges are arranged with: (i) a first strain gauge affixed to a first beam, (ii) a second strain gauge affixed to a second beam extending opposite the first beam, (iii) a third strain gauge affixed to a third beam, and (iv) a fourth strain gauge affixed to a fourth beam extending opposite the third beam. The wiring arrangement includes a plurality of wiring pairs arranged parallel to each other and in a substantially arcuate path along a radial position. The plurality of wiring pairs of the wiring arrangement includes: a first wiring pair connecting the first strain gauge to the second strain gauge, and a second wiring pair connecting the third strain gauge to the fourth strain gauge. The wiring arrangement can further include a third wiring pair connecting the second strain gauge to the third strain gauge, and a fourth wiring pair connecting a center tap of each wire of the third wiring pair to the first and second output signal connections. The wiring arrangement can further include a fifth wiring pair connecting the first strain gauge to the voltage source, and a sixth wiring pair connecting the fourth strain gauge to the ground. The sensor assembly can include a board assembly comprising a plurality of PCB board layers and a plurality of wiring pairs forming conductive electrical paths on one or more layers of the board assembly.

### BRIEF DESCRIPTION OF THE DRAWINGS

The drawing figures depict one or more implementations in accordance with the present teachings by way of example only, not by way of limitation. In the figures, like reference numerals refer to the same or similar elements.

FIG. 1 is a perspective view of a first illustrative humanoid robot in an upright, standing position, with arms extended outward, and comprising at least: (i) a head, (ii) a torso, (iii) left and right shoulders, (iv) left and right arms, (v) left and right hips, and (vi) left and right legs, wherein the robot contains various actuators arranged within the robot to actuate movement and is shown with the left and right arms extended by at least actuators positioned at the shoulder;

FIG. 2 is a perspective view of a second illustrative humanoid robot in an upright, standing position, and comprising at least: (i) a head, (ii) a torso, (iii) left and right shoulders, (iv) left and right arms, (v) left and right hips, and (vi) left and right legs, wherein the robot contains various actuators arranged within the robot to actuate movement and is shown with the arms at its sides;

FIG. 3 is an exploded view of a first embodiment of a reaction-type torque cell coupled to a first embodiment actuator housing of a rotary actuator contained in the robot of FIG. 1 or FIG. 2, wherein the reaction-type torque cell includes: (i) a flexure element integrally formed with an extent of the actuator housing of the rotary actuator, (ii) a torque sensor assembly coupled to the flexure element, and (iii) a protective shield;

FIG. 4 is a front perspective view of the reaction-type torque cell of FIG. 3;

FIG. 5 is a rear perspective view of the reaction-type torque cell of FIG. 3;

FIG. 6 is a front view of the reaction-type torque cell of FIG. 3, wherein the torque sensor assembly has been removed to better show the flexure element that is integrally formed with an extent of the actuator housing, and showing the flexure element including an inner ring, an outer ring, and a plurality of beams, where dashed lines indicate the location of the beams and separation structures;

FIG. 7 is a rear view of the reaction-type torque cell of FIG. 3, wherein the protective shield is removed from the flexure element to better show the flexure element that is integrally formed with an extent of the actuator housing, where dashed lines indicate the location of the beams and separation structures;

FIG. 8 is a front view of the reaction-type torque cell of FIG. 3;

FIG. 9 is a zoomed in view of the measurement section of the beam in FIG. 11, showing a sensor recess formed in the beam;

FIG. 10 is a first cross-sectional view of the flexure element taken along line 10-10 of FIG. 8, showing a thickness profile of a support section of the radial beam and a taper angle (α) defined between the first taper surface and a horizontal reference plane;

FIG. 11 is a second cross-sectional view of the flexure element taken along line 11-11 of FIG. 8, showing a thickness profile of a measurement section of the radial beam and the taper angle (α);

FIG. 12 is a third cross-sectional view of the flexure element taken along line 12-12 of FIG. 8, showing a thickness profile of the separation structure between the radial beams;

FIG. 13 is a perspective view of the flexure element integrally formed within an extent of the actuator housing of FIG. 3, shown with a color scale of the thickness values;

FIG. 14 is a front view of the flexure element integrally formed within an extent of the actuator housing of FIG. 13, shown with a color scale of the thickness values;

FIG. 15 is a perspective view of the flexure element of FIG. 3 illustrated with arrows indicating a torque load about a central axis (A_{c});

FIG. 16 is a perspective view of the flexure element of FIG. 3 illustrated with arrows indicating a radial load acting on the central axis;

FIG. 17 is a section view of the flexure element of FIG. 3 taken along line 17-17 of FIG. 7, and illustrated with arrows indicating a moment load about a reference axis (Aᵣ) through a central thickness of the flexure element;

FIG. 18 is a section view of the flexure element of FIG. 3 taken along line 18-18 of FIG. 7, and illustrated with arrows indicating an axial load distributed about the central axis;

FIG. 19 is a top view of a simplified diagram of the flexure element of FIG. 3 with four double element strain gauges applied to the beams and illustrated with arrows indicating a clockwise torque load applied to the outer ring and arrows indicating the tension and compression loads caused by the applied torque;

FIG. 20 illustrates an embodiment of a double element strain gauge of FIG. 19, showing: (i) a first resistance gauge element having an active grid area arranged at (minus) -45 degrees on the left side, and (ii) a second resistance gauge element having an active grid area arranged on the right side at (plus) +45 degrees symmetric to a radial midline of the beam;

FIG. 21 is a circuit diagram of a Wheatstone bridge representing the electrical connections of the resistance gauges of the double element strain gauges of FIG. 19, wherein the arrows indicate the first resistance gauge elements R1, R2, R7, R8 are in tension and the second resistance gauge elements R3, R4, R5, R6 are in compression;

FIG. 22 is a schematic wiring diagram of the strain gauges of FIG. 19 with simple wire connections in the Wheatstone bridge arrangement of FIG. 21, shown with an illustrative magnet (M) moving over, perpendicular to, and across the wiring between R7 and R8;

FIG. 23 is the Wheatstone bridge diagram of FIG. 21, shown with illustrative voltage changes over the resistance gauge elements, where the magnetic field of FIG. 22 induces a voltage across the trace wiring between R7 and R8;

FIG. 24 is a schematic wiring diagram of the strain gauges of FIG. 20 in the Wheatstone bridge arrangement of FIG. 21, wherein the order of the individual resistance gauge elements has been reassigned in a parallel wiring configuration to reduce induced current;

FIG. 25 illustrates a top, first layer of a board assembly of the torque sensor assembly shown in FIG. 3, including an extent of the wiring shown in FIG. 24;

FIG. 26 illustrates a second layer of a board assembly of the torque sensor assembly shown in FIG. 3, including an extent of the wiring shown in FIG. 24;

FIG. 27 illustrates a third layer of a board assembly of the torque sensor assembly shown in FIG. 3, including an extent of the wiring shown in FIG. 24;

FIG. 28 illustrates a bottom layer of a board assembly of the torque sensor assembly shown in FIG. 3, including an extent of the wiring shown in FIG. 24;

FIG. 29 is an exploded view of a second embodiment of a reaction-type torque cell coupled to a second embodiment actuator housing of a rotary actuator contained in the robot of FIG. 1 or FIG. 2, wherein the reaction-type torque cell includes: (i) a flexure element integrally formed with an extent of the actuator housing of said rotary actuator, (ii) a torque sensor assembly coupled to the flexure element, and (iii) a protective shield, and wherein the flexure element is symmetric about the center axis and asymmetric about a neutral plane;

FIG. 30 is a front view of the second embodiment of the reaction-type torque cell of FIG. 29, wherein the torque sensor assembly coupled to the flexure element has been removed to better show the flexure element that is integrally formed with an extent of the actuator housing;

FIG. 31A is a zoomed in view of the measurement section of the beam in FIG. 31B, showing a sensor recess formed in the beam;

FIG. 31B is a cross-sectional view of the second embodiment of the reaction-type torque cell taken along line 31B-31B of FIG. 30;

FIG. 32 is a front perspective view of a third embodiment of a reaction-type torque cell coupled to a third embodiment actuator housing of a rotary actuator contained in the robot of FIG. 1 or FIG. 2, wherein the reaction-type torque cell includes: (i) a flexure element integrally formed with an extent of the actuator housing of said rotary actuator, (ii) a torque sensor assembly coupled to the flexure element, and (iii) a protective shield, shown without a torque sensor assembly;

FIG. 33 is a front view of the reaction-type torque cell shown in FIG. 32;

FIG. 34 is a cross-sectional view of the reaction-type torque cell taken along line 34-34 shown in FIG. 33;

FIG. 35 is a rear view of the reaction-type torque cell shown in FIG. 32;

FIG. 36 is a cross-sectional view of the reaction-type torque cell taken along line 36-36 shown in FIG. 35;

FIG. 37 is a perspective view of a fourth embodiment of a reaction-type torque cell coupled to a fourth embodiment actuator housing of a rotary actuator contained in the robot of FIG. 1 or FIG. 2, wherein the reaction-type torque cell includes: (i) a flexure element, (ii) a torque sensor assembly coupled to the flexure element, and (iii) a protective shield, wherein the strain gauges of FIG. 20 are applied to the flexure element and coupled to the torque sensor assembly according to the wiring arrangement of FIG. 24;

FIG. 38 is an exploded view of the reaction-type torque cell of FIG. 37;

FIG. 39 is a front view of the reaction-type torque cell and the actuator housing of FIG. 37;

FIG. 40 is a cross-sectional view of the reaction-type torque cell and actuator housing taken along line 40-40 of FIG. 39;

FIG. 41 is a front perspective view of a fifth embodiment of a reaction-type torque cell coupled to a fifth embodiment actuator housing of a rotary actuator contained in the robot of FIG. 1 or FIG. 2, wherein the reaction-type torque cell includes: (i) a flexure element with a varying thickness and that is integrally formed with (a) an extent of the actuator housing of the rotary actuator and (b) a flexible externally-toothed gear, (ii) a torque sensor assembly coupled to the flexure element, and (iii) a protective shield;

FIG. 42 is a front view of the reaction-type torque cell of FIG. 41;

FIG. 43 is a cross-sectional view of the reaction-type torque cell taken along line 43-43 of FIG. 42;

FIG. 44 is an exploded view of a sixth embodiment of a reaction-type torque cell coupled to a sixth embodiment actuator housing of a rotary actuator contained in the robot of FIG. 1 or FIG. 2, wherein the reaction-type torque cell includes: (i) a flexure element that is integrally formed with a flexible externally-toothed gear, (ii) a torque sensor assembly coupled to the flexure element, and (iii) a protective shield, wherein the torque cell is coupled to the actuator housing with fasteners;

FIG. 45 is a front perspective view of the reaction-type torque cell and the actuator housing of FIG. 44;

FIG. 46 is a front view of the reaction-type torque cell and the actuator housing of FIG. 45; and

FIG. 47 is a cross-sectional view of the reaction-type torque cell and the actuator housing taken along line 47-47 of FIG. 46.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

### A.Introduction

General-purpose humanoid robots can emulate human form and functionality with two legs, two arms, and a face-like screen. Enabling such a robot system to execute human tasks poses countless challenges due to the vast array of potential positions, locations, and states said robots could occupy at any given time in a challenging operating environment. With the general-purpose humanoid robot’s emulation of the human body (and specifically for dexterous tasks), a need arises to know the exact position and forces exerted by and/or placed on the actuator at any given time. To help obtain said position and/or forces, said actuator can have a sensor package that may include: (i) a torque cell (e.g., reaction-type or output-type), (ii) encoders (e.g., absolute, incremental, optical, magnetic, etc.), (iii) temperature sensors, and (iv) other sensors.

The reaction-type torque cells disclosed herein measure torque without the complexities and potential error sources introduced by rotation, such as centrifugal forces or shaft misalignment. The absence of moving parts reduces noise and signal fluctuations, leading to more precise and reliable torque measurements. The simpler mechanical design of the inventive reaction-type torque cells can be easier to install and can reduce errors from off-axis loads. In particular, the disclosed reaction-type torque cells include recessed or sunken portions in the radial beams that include surfaces that lie in or near the neutral plane to minimize the off-axis loads. The neutral plane (NP) is a conceptual reference plane within the beams where the material is not under stress. For example, the neutral plane is usually located in the center of a uniform section of the beam. Further, the shape and thickness profile of the flexure element are designed to reduce errors in measurement.

As described in greater detail below, the reaction-type torque cell described in this Application includes: (i) a flexure element, (ii) a sensor assembly, and (iii) a protective shield. In various embodiments, the flexure element is integrally formed with or as part of the actuator housing. For example, the flexure element and the actuator housing can be formed in a single, cost-effective manufacturing process (e.g., die-casting). In other embodiments, the flexure element can be coupled to the actuator housing using fasteners. Once the actuator housing and flexure element are formed or coupled to one another, then: (i) the sensor assembly is coupled to said flexure element on one side, and (ii) the protective shield is installed on the opposite side of the flexure element and oriented towards a motor to be installed. The sensor assembly includes an arrangement of strain gauges affixed to the flexure element to measure strain caused by applied loads and means to convert the measurement to an electrical output that can be processed to determine the torque (e.g., measured in N-m or ft-lbs) provided by said actuator. The protective shield is configured to reduce, and potentially eliminate, electromagnetic interference (EMI) to the sensor assembly from the motor or other mechanical components.

In various embodiments, the flexure element incorporates a varying thickness designed to achieve several objectives: (i) reduce errors in torque measurements by optimizing strain distribution within a given stress measurement range; (ii) minimize localized stress concentrations; (iii) increase ease and accuracy of calibration; (iv) reduce overall weight; and (v) provide a more compact design. By carefully designing the thickness profile, the flexure element distributes strain more evenly across its structure. This optimization of the flexure element’s thickness reduces the amount of noise captured in the measurements and helps maintain a more linear relationship between applied torque and resulting strain. The improved linearity simplifies and eases positional requirements for the strain gauges and enhances the reaction-type torque cell's overall performance, including its accuracy and reliability. Minimizing localized stress concentrations decreases the likelihood of premature failure and reduces cyclic stress, potentially extending the reaction-type torque cell's fatigue life. Tailoring the flexure element to specific application requirements or measurement ranges enhances its responsiveness and accuracy. Selective thinning of non-critical areas lowers the overall weight of the flexure element without significantly compromising its strength or performance. This weight reduction contributes to a more compact reaction-type torque cell design, facilitating integration into applications with space constraints. Additionally, varying the thickness can compensate for temperature-induced errors by balancing thermal expansion effects, further improving measurement accuracy under varying environmental conditions, including harsh operating environments for the humanoid robot.

The flexure element disclosed herein can be (i) integrated into the actuator housing, as shown in an illustrative embodiment, or (ii) formed separately with an outer mounting portion configured to couple to an actuator housing. The coupling configuration of the flexure element to the actuator housing may be determined by the specified design requirements for the robot, among other factors. Integrating the flexure element into the housing can be cheaper, reduce total part count, and reduce failure modes. For example, the flexure element and the actuator housing can be formed in a single, cost-effective manufacturing process (e.g., die-casting). Although the manufacturing process may limit the material selection, which may introduce errors in the measurements of said reaction-type torque cell, most, if not all, of the material-related errors can be identified and then compensated for in the configuration of the geometry of the flexure element and/or other means.

Alternatively, the separate flexure element with an outer mounting portion provides other manufacturing options and can be manufactured in a location that is remote from the location where the housing is manufactured, which can reduce manufacturing costs. This allows the use of more accurate materials, while machining can increase accuracy over casting. However, coupling the torque cell to other components of the actuator or the actuator housing using conventional fasteners can: reduce the ability of the torque cell to detect and measure the exact torque of the actuator due to the coupling arrangement, increase the number of points for mechanical failure, be more costly to create (e.g., cost of machining vs casting), and increase assembly time.

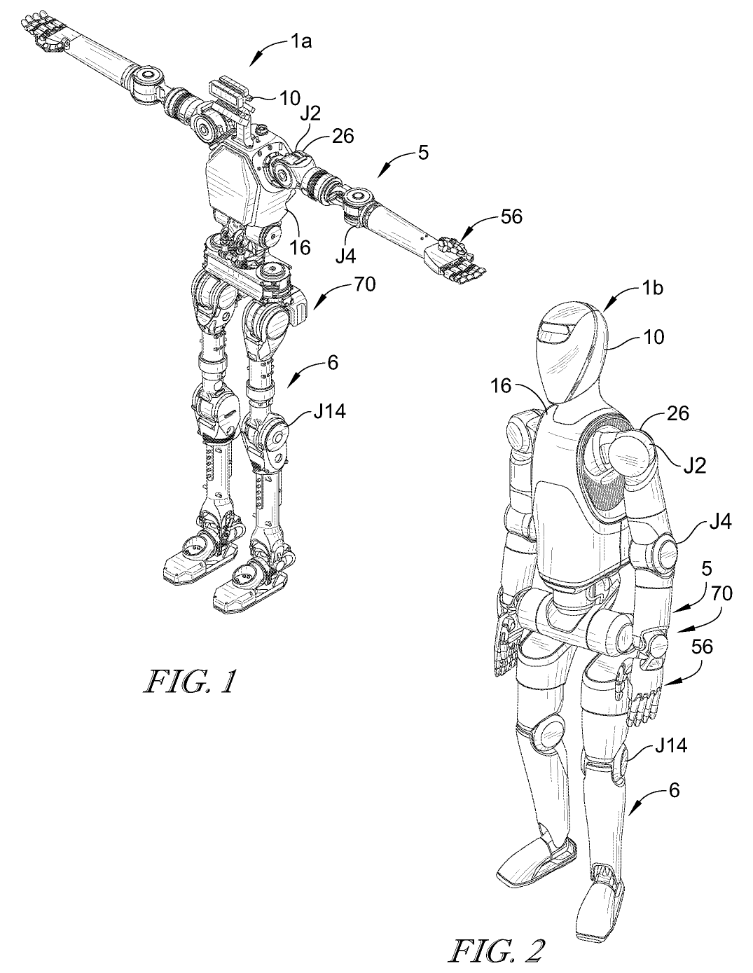

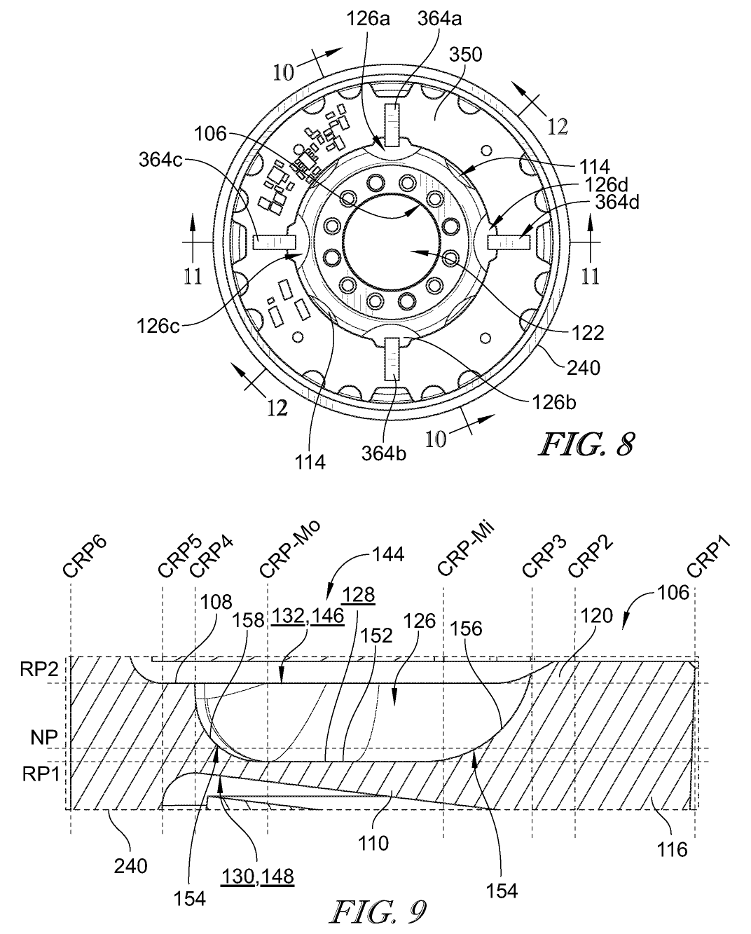

While this Application contemplates multiple different types and configurations of the flexure element, the flexure element shown in the figures include the following portions: (i) an inner ring or hub, (ii) an outer ring or rim, and (iii) multiple radial beams connecting the inner hub and outer rim. As shown in FIGS. 1-18, the illustrative embodiment shows the flexure element may include an outer rim that is integrally formed with an extent of the actuator housing, other embodiments include a separate flexure element coupled to an actuator housing with fasteners or other coupling means. The configuration of each portion of said flexure element is selected to provide the desired stiffness and strain sensitivity. In particular, the configuration (e.g., varying thickness, width, and overall shape) and arrangement of the radial beams is particularly important because said radial beams are designed to deform in a predictable way when torque is applied thereto. The torque sensor can measure this predictable deformation, which may be relayed to the actuator electronics, and/or then sent to a remote assembly or system (e.g., robot controller). Unlike conventional torque cells, the disclosed torque cell includes at least the following advantages: (i) high sensitivity to on-axis torsional loads, (ii) excellent rejection of off-axis loads, (iii) good overload protection due to the distributed load path, (iv) compact design, (v) limits mechanical failure points, (vi) simplifies assembly of the actuator, (vii) decreases assembly time of the actuator, and (viii) provides other benefits that are known to one of skill in the art.

### B.Actuator Housing

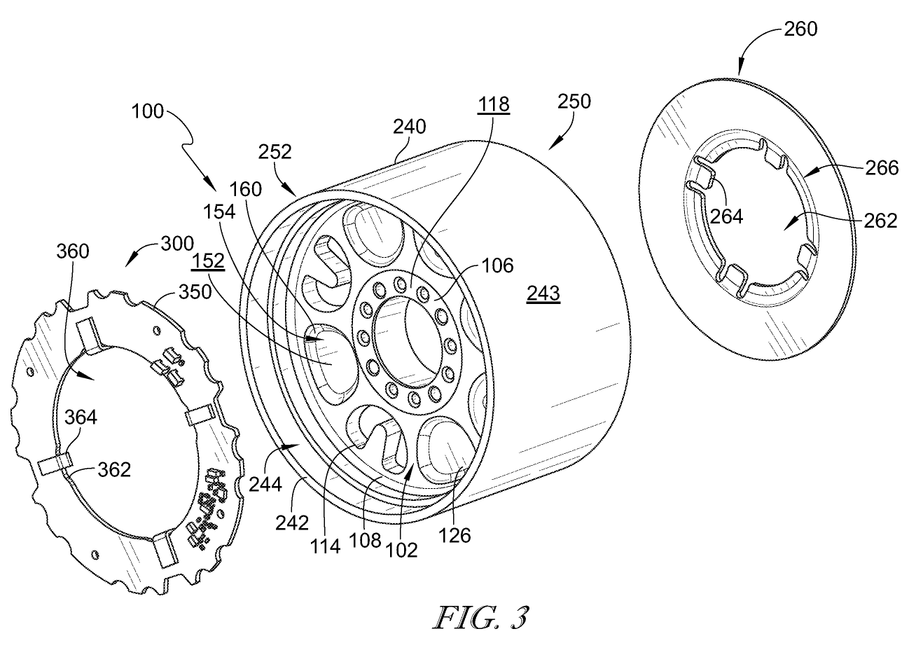

Illustrative examples of a humanoid robot 1 are shown in FIGS. 1 and 2, each of which includes a plurality of actuators that can control the movement of at least one of the robot’s components. Examples of said components of the humanoid robot include: (i) a head 10, (ii) a torso 16, (iii) left and right shoulders 26, (iv) left and right arms 5, (v) left and right hips 70, and (vi) left and right legs 6. The positioning of certain actuators contained within the illustrative robot 1 are indicated as joints, for example the elbow actuator (J4) and knee actuator (J14), or may be contained within the housing (e.g., exoskeleton) of the robot 1 to improve the range of motion of connected components. The actuator size and performance can be scaled based on the torque required for movement and range of motion. For example, an actuator (J2) in the shoulder 26 may require more torque to move the entire arm 5 than the wrist actuator (J7) that moves the position of the hands 56. Similarly, the knee actuator (J14) may require more operating torque than the elbow actuator (J4). As such, an illustrative actuator housing 240 (FIGS. 3-18) can further contain other components of the actuator assembly and can be sized, scaled, or modified as needed for a specified placement within the robot 1. Although robots 1A and 1B show examples of positions and sizes of various actuators that may be used within a humanoid robot, the concepts disclosed herein can be relied on for electric actuators of various sizes and configurations and are not limited to the illustrative examples shown.

As shown in FIGS. 3-5 and 10-12, the actuator housing 240 of the illustrative actuator has a substantially cylindrical configuration that can be scaled for various outer (dₒ) and inner diameters (d₁-d₆) forming cavities within an interior portion 244 (FIG. 10). These diameters (d_{o,} d₁-d₆) are configured to provide the smallest overall actuator package size for the selected actuator components (e.g., motor, shafts, gears, etc.). For example, the actuator can include a harmonic gear/strain wave gear arrangement with aflexible externally-toothed gear or flexcup. In other embodiments, the mechanical gear contained within the actuator may include any type of mechanical gear, including spur gears, worm gear, rack gear, screw gear, bevel gear, screw beveled gear, or internal toothing. These gears may be arranged as part of a mechanical gear system such as a planetary gear system/epicyclic gear train, cycloidal drive or cycloidal speed reducer, worm drive, gravity compensation system, and/or cable system. Said systems or gearing may be compound or not compound. The reduction ratios provided by the mechanical gear systems may be any reduction ratio including 1:1.1 to 1:150. In particular, said reduction ratio may be 1:10, 1:20, 1:30, 1:50, and/or 1:100. In other examples, said reduction ratio may be less than 1:1.1 or it may be more than 1:150.

In various embodiments, the housing 240 can include a vent, or other structural features configured for coupling the actuator with one or more robot components. Said vent may be utilized for active or passive cooling of the actuator, and specifically the motor contained therein. Further, the exterior surface 243 of the housing 240 may be customized for a particular use within the robot 1 without changing the interior dimensions of the housing 240 or the properties of the flexure element 102 contained therein. For example, the actuator housing 240 can be integrally formed with another robot component or housing that may alter the external surface of the housing 240. Moreover, the housing 240 may be designed to provide structural support for the humanoid robot 1 and/or act as a heat sink for said actuator (wherein said actuator housing may include fins that extend from an outer surface of said actuator).

As shown in at least FIGS. 3 and 10-12, the illustrative housing 240 can have a sidewall 242 with a substantially cylindrical exterior surface 243 and an interior portion 244 configured to be coupled with the integrated flexure element 102 located therein. The actuator housing 240 can have a length (l) in the axial direction, where the flexure element 102 is positioned at least partially offset from a midpoint 270 (l/2) of the length (l), wherein said length (l) extends from a first edge 272 to an opposed edge 274 within the interior portion 244. In various embodiments, a greater thickness of the sidewall 242 can provide structural reinforcement where the flexure element 102 is coupled to the sidewall 242 of the housing 240. For example, a central extent 246 of the sidewall 242 can have a thickness that is greater than other portions of the sidewall 242 to reinforce or be integrated with an outer rim 108 of the flexure element 102 coupled to the housing 240. Specifically, as shown in FIG. 10, a central extent 246 of the housing sidewall 242 can have a thickness (t₁) at a first location that is greater than the thickness (t₂) at a second location that is near or adjacent to the first edge 272 of the housing.

The interior portion 244 can include cavities of various diameters (d₁-d₆) forming a stepped internal profile and providing an interior space or volume configured to accommodate selected actuator components. For example, the interior portion 244 of the housing sidewall 242 may further include an internal ledge or groove 248 with a diameter (d₃) configured to accommodate an extent of the sensor board 350 of the sensor assembly 300. In general terms, the actuator housing 240 has a motor side 250 and an output side 252 within the interior portion 244 that is at least partially defined by the position of the flexure element 102. The motor side 250 can be configured to receive a motor, among other components, and the output side 252 that can couple to a shaft, gears, etc.

### C.Reaction-Type Torque Cell

The illustrative reaction-type torque cell or torque cell 100 shown in FIGS. 3-18 includes: (i) a flexure element 102 that is integrally formed with the actuator housing 240, (ii) a sensor assembly 300, and (iii) a protective shield 260. The sensor assembly 300 is positioned adjacent and coupled to the flexure element 102 on the output side 252 of the actuator housing 240, whereas the protective shield 260 is coupled to the flexure element 102 on the motor side 250 of the actuator housing 240. In other embodiments, the protective shield 260 may not be coupled to the flexure element 102 and instead may be coupled to the housing 240, a motor, or another component contained in the housing.

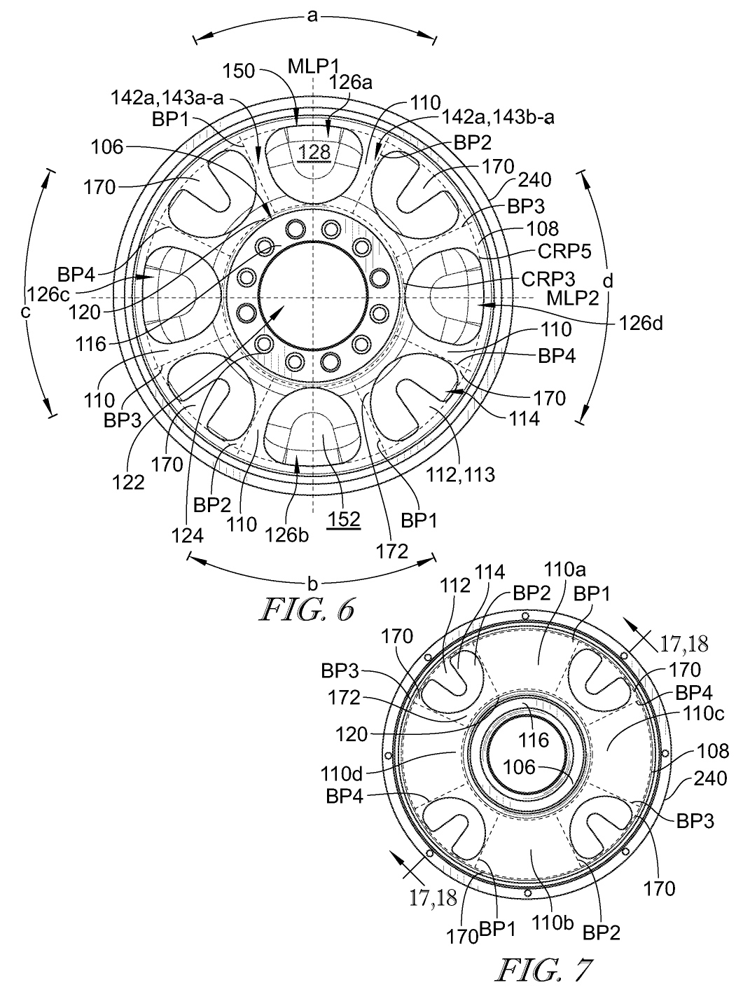

As shown in FIG. 6, the flexure element 102 includes: (i) an inner hub 106 (also referred to as a hub, gear coupling member, output mount, or inner ring 106), (ii) an outer rim 108 (also referred to as a rim, securement member, housing coupler, or outer ring 108) coupled to the actuator housing 240, and (iii) a plurality of radial beams 110 that extend between the inner hub 106 and outer rim 108. The flexure element 102 can be designed to cause an extent of at least one, and preferably an extent of a plurality of the radial beams 110, to deform when torque is applied to the inner hub 106 or outer rim 108. The deformation of said extent of the radial beams 110 can be accurately measured by the sensor assembly 300. To optimize the deformation of the radial beams 110 for the desired actuator specification (e.g., load, torque, etc.), said flexure element 102 can be analyzed using Finite Element Analysis (FEA) to: (i) select material properties of the flexure element 102, (ii) identify a manufacturing process, including whether heat treating will be used to further harden the entire assembly or portions thereof, (iii) optimize beam geometry for desired strain levels, (iv) ensure stress levels remain within safe limits, (v) predict natural frequencies and mode shapes, and/or (vi) analyze the behavior of the flexure element 102 under various load conditions.

### a.Flexure Element

In FIGS. 3-18, the flexure element 102 is integrally formed with the housing 240. Any known method of manufacturing said integrally formed flexure element 102 and housing 240 may be used, including die-casting, 3D printing, or machining using a subtractive manufacturing process (e.g., milling using a CNC machine, etc.). In some embodiments (some of which are discussed below), the flexure element 102 can be formed separate from the housing 240 and further include an outer mounting portion, where the outer mounting portion extends radially outward from the outer rim 108 to provide a mounting structure to couple the flexure element 102 to the housing 240.

The illustrative flexure element 102 may be manufactured from a single piece of metal, wherein the inner hub 106, the outer rim 108, and radial beams 110 are integrally formed with one another. The integrally formed housing 240 and flexure element 102 (including the inner hub 106, outer rim 108, and radial beams 110) may be formed from high-strength aluminum alloys (e.g., 7075-T6, 2024-T3, etc.), stainless steel (e.g., 17-4 PH, 15-5 PH, etc.), tool steel (e.g., AISI 4340, etc.), beryllium copper (e.g., copper beryllium, beryllium bronze, and spring copper, etc.), nickel-chromium-based superalloys (e.g., Inconel®, etc.), titanium alloys (e.g., Ti-6Al-4V, etc.), and the like. The flexure element 102 also can be made of advanced alloys such as a cobalt-chromium-nickel alloy (e.g., Elgiloy®), a nickel-iron alloy with low thermal expansion (e.g., Invar®), a nickel-chromium alloy (e.g., Nichrome), and the like. It is noted that in some examples, a cast version of the torque cell can result in undesirable errors compared to a machined and bolted versions of the torque cell. As discussed above, this error may be fully, or at least partially, compensated for by: (i) configuration of the geometry of the openings, thicknesses, and overall design, (ii) inclusion of a temperature sensor, and/or (iii) software algorithm to actively adjust for a predictable estimated error.

In other embodiments, the flexure element 102 may not be made from metal, wherein said flexure element 102 may be made from any one or any combination of the following materials: carbon fiber reinforced polymers (CFRP), glass fiber reinforced polymers (GFRP), aramid fiber reinforced polymers (e.g., Kevlar® composites), polyetheretherketone (PEEK), polyetherimide (PEI, e.g., Ultem®), polyamide-imide (PAI), polyphenylene sulfide (PPS), carbon nanotube-reinforced polymers, thermoplastic polyurethanes (TPU), epoxy resins reinforced with fibers, polyimides (PI), fiber-reinforced thermoplastics (e.g., reinforced nylons), shape memory polymers (SMPs), or polylactic acid (PLA) composites. Further, the inner hub 106, outer rim 108, and radial beams 110 may not be integrally formed with one another, and instead may be separate and distinct components. For example, said radial beams 110 may be: (i) coupled to both the hub 106 and the outer rim 108, (ii) coupled to the inner hub 106 and integrally formed with the outer rim 108, or (iii) coupled to the outer rim 108 and integrally formed with the inner hub 106. Said coupling of the radial beams 110 to another structure may be accomplished using threaded fasteners, glue/epoxy, clips, press-fit, or any other coupling means.

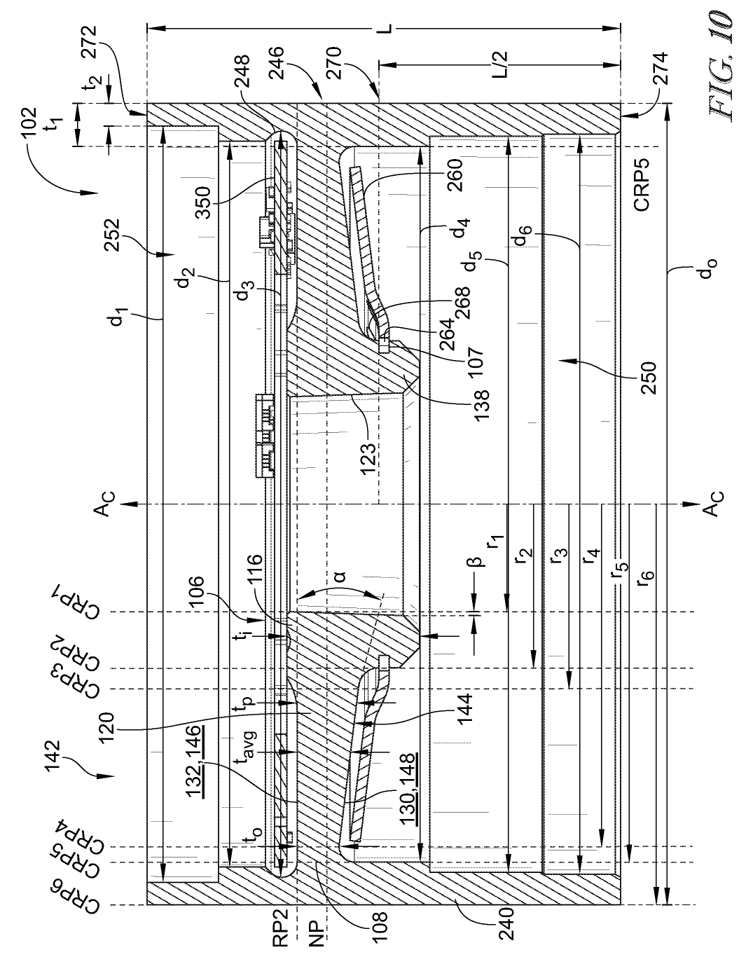

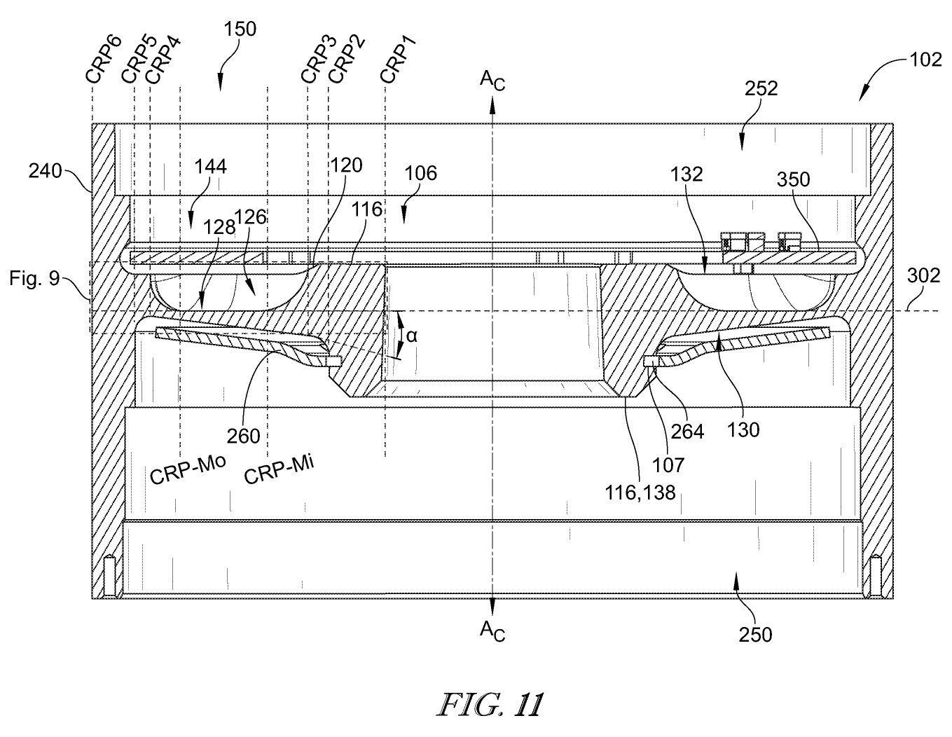

The flexure element 102 includes several cylindrical reference planes (CRP1-CRP6) that further define the configuration of the flexure element 102 and its components. As shown in at least FIGS. 9-12, a first cylindrical reference plane (CRP1) is defined at a first radius (r₁) about the central axis (A_{c}) at the innermost point of the inner hub 106 at the central opening 122. The inner wall 123 of the flexure element at the central opening 122 is sloped at an angle (β) to the central axis (A_{c}). For example, the angle (β) can be between about 0 to 4 degrees (FIG. 10). A second cylindrical reference plane (CRP2) is defined at a second radius (r₂) at the change between a mounting portion 116 and a transition portion 120 of the inner hub 106. A third cylindrical reference plane (CRP3) is defined at a third radius (r₃) indicating an innermost radius of the tapered section 144 (prior to any transition fillet or chamfer). A fourth cylindrical reference plane (CRP4) is defined at a fourth radius (r₄) indicating an outermost radius of the tapered section 144 (prior to any transition fillet or chamfer). A fifth cylindrical reference plane (CRP5) is defined at a fifth radius (r₅) at the transition between the outer rim 108 and the housing 240. A sixth cylindrical reference plane (CRP6) is defined at a sixth radius (r₆) at the exterior surface 243 of the housing 240. The third cylindrical reference plane (CRP3) and the fifth cylindrical reference plane (CRP5) are further shown in FIG. 6 as dashed circles.

### i.Inner Hub

The inner hub 106 is configured with sufficient rigidity to distribute loads evenly to the beams 110 and without experiencing warping or distortion. To effectuate this load distribution, the inner hub 106 includes: (i) a central opening 122, (ii) a mounting portion 116, defined between first cylindrical reference plane (CRP1) and the second reference plane (CRP2), and (iii) a radial transition portion 120, defined between the second reference plane (CRP2) and the third cylindrical reference plane (CRP3). The mounting portion 116 contains (i) a plurality of mounting features (e.g., apertures 124) formed in a mounting surface 118 on the output side 252 and configured for further assembly of the actuator, and (ii) an engagement projection 138 on the motor side 250, which is an extent of the mounting portion 116 of the inner hub 106 that protrudes from the second surface 130. The inner transition portion 120 provides a transition from the inner mounting portion 116 to a tapered section 144 of the beam 110. The central opening 122 in the hub or inner hub 106 allows for wires to pass through the bore of the actuator; however, if through-bore wiring is not possible due to the size of the actuator or is not necessary, the central opening 122 may be omitted.

The plurality of mounting features (e.g., apertures 124) included in the inner hub 106 are configured to secure an extent of the actuator (e.g., aflexible externally-toothed gear of a hollow-type strain wave gear) to the flexure element 102. To ensure this securement, the thickness of the inner hub 106 is configured to accept conventional fasteners (e.g., threaded fasteners). As such, the hub or inner hub 106 at the mounting portion 116 has a thickness (tᵢ) greater than an average thickness (t_{avg}) of the beams 110 (FIG. 10). The inner hub 106 may protrude from both a first surface 132 and the second surface 130, or may only protrude from only the second surface 130. The inner hub 106 further includes a slot or mounting groove 107 formed in an outer circumference of the engagement projection 138, which is an extent of the mounting portion 116 of the inner hub 106 that protrudes from the second surface 130. The mounting groove 107 is configured to receive and couple with the protective shield 260.

For example, in the illustrative embodiment, the thickness of the flexure element 102 can have a thickness (tᵢ) at the mounting portion 116 of the inner hub 106 of 9 mm to 16 mm, preferably about 10.4 mm to 15.6 mm, and most preferably about 11.7 mm to 14.3 mm. The thickness of the transition portion 120 of the inner hub 106 can be about 5.6 mm to 8.4 mm, preferably about 6.3 mm to 7.7 mm adjacent to the mounting portion 116 (e.g., tₚₘ at CRP2) and transition to about 4.8 mm to 7.2 mm, preferably 5.4 mm to 6.6 mm at the tapered section 144 (e.g., tₚ at CRP3). The engagement projection 138 of the mounting portion 116 can extend about 5.6 mm to 8.4 mm, preferably about 6.3 mm to 7.7 mm from the first surface 132, where the transition portion 120 meets the mounting portion 116.

### ii.Outer Rim

Like the inner hub 106, the outer rim 108 is configured to be sufficiently rigid to distribute loads evenly without appreciable distortion to the radial beams 110. To effectuate this load distribution, the outer rim 108 is integrally formed with the actuator housing 240. As such, said outer rim 108 extends outward from the fourth cylindrical reference plane (CRP4) (i.e., at an outermost radius of the tapered section 144) to the inner surface of the housing 240 at the fifth cylindrical reference plane (CRP5). As shown in FIG. 10, the outer rim 108 may have a thickness (tₒ) that is less than the mounting thickness (tᵢ) of the mounting portion 116 or a transition thickness (tₚ) of the transition portion 120 of the inner hub 106. Although the outer rim 108 can have varying thicknesses, the outer ring thickness (tₒ) is defined at the fourth cylindrical reference plane (CRP4), the change between an outermost radius of the tapered section 144 of the beam 110 and the outer rim 108. Similarly, the inner hub 106 can have varying thicknesses; as such, the mounting thickness (tᵢ) at the mounting portion 116 is a maximum thickness of the inner hub 106, and the transition thickness (tₚ) is a minimum thickness of the inner hub 106 in the transition portion 120 at the third cylindrical reference plane (CRP3), the change between the transition portion 120 and the innermost radius of the tapered section 144 of the beam 110. The thickness of the outer rim 108 can be substantially similar to an extent of the beam 110 that is adjacent to the outer rim 108 at the fourth cylindrical reference plane (CRP4). Together the outer rim 108 and the beams 110 define: (i) a first surface 132, and (ii) an opposite second surface 130 of the flexure element 102. Additionally, because the actuator housing 240 has a cylindrical configuration and there are no gaps formed between the flexure element 102 and the housing 240, the rim or outer ring 108 also has a substantially cylindrical configuration. In other embodiments, the rim or outer ring 108 may not have a cylindrical configuration; instead, the rim or outer ring 108 may be integrally formed with the housing 240 at select locations and/or may have locations formed therein that are raised or recessed relative to the surrounding surfaces.

### iii.Radial Beams

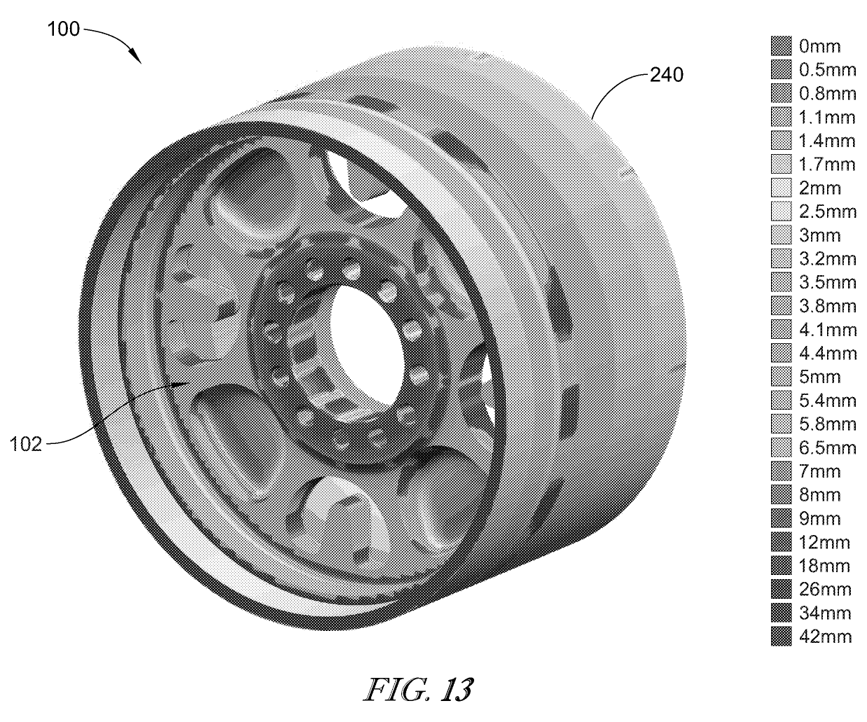

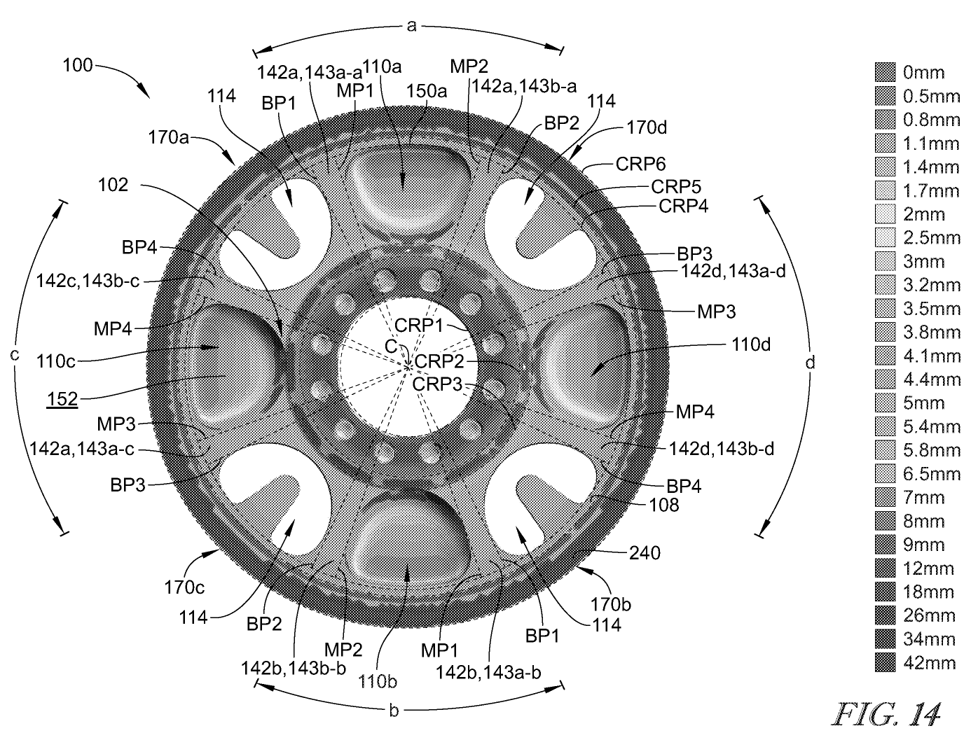

As shown in at least FIGS. 6, 7, and 14, an arrangement of radial beams 110 extend between the inner hub 106 and outer rim 108 of the flexure element 102. In the embodiment shown in these Figures, the radial beams 110 are spaced apart from one another by separation portions 170 (e.g., intermediate, non-beam, non-active, or non-sensing portions) and as a result, the radial beams 110 are interspersed with the separation portions 170 (as discussed below). As shown in FIG. 14, radial beam planes (BP1, BP2, BP3, BP4) are planes that extend radially intersecting at a center-point (C). As shown in FIG. 6, the dashed lines of the beam planes (BP1 - BP4) that extend radially between the circular dashed lines (CRP3 and CRP5) indicate the radial beams 110 and separation portions 170. In other words, the first beam 110a extends between BP1 reference plane and BP2 reference plane (top), the second beam 110b extends between BP1 reference plane and BP2 reference plane (bottom), the third beam 110c extends between BP3 reference plane and BP4 reference plane (left), and the fourth beam 110d extends between BP3 reference plane and BP4 reference plane (right). As such, there are four radial beams 110, wherein each beam 110 is oriented 90 degrees from the adjacent two beams 110.

As shown in FIG. 14, the beams 110 can be further defined by measurement reference planes (MP1, MP2, MP3, MP4) that extend radially intersecting at a center-point (C). The radial beams 110 (e.g., individually 110a-110d) can include: (i) a pair of support sections 142 (e.g., individual beams include 142a-142d) including a first section 143.1a and a second section 143.1b (e.g., individual beams include 143a-a-143a-d, 143b-a-143b-d), and (ii) a measurement section 150. For example, the first beam 110a (top) includes a first section 143a-a that is defined between BP1 reference plane and MP1 reference plane, and the second section 143b-a that is defined between MP2 reference plane and BP2 reference plane, and a measurement section 150a is defined between MP1 reference plane and MP2 reference plane, that resides between the pair of support sections 142. As shown in FIGS. 10-11 and 14, the radial beams 110 can have a varying thickness that tapers from the inner hub 106 (i.e., tₚ at CRP3) to the outer rim 108 (i.e., tₒ at CRP4). The varying thickness is configured to achieve a more uniform strain field in the radial orientation.

As shown in FIGS. 6, 9, and 11, a sunken portion 126 of each radial beam 110 is formed in the measurement section 150. The sunken portion 126 has a recessed surface 128 that is recessed downward from the first surface 132 into the thickness of each beam 110, which further reduces the local beam thicknesses within the sunken portion 126. Referring to FIGS. 9 and 10, the recessed surface 128 of the radial beams 110 includes a planar gauge surface portion 152 that is configured to reside in a first reference plane (RP1) that is parallel to a second reference plane (RP2) that extends perpendicular to the center axis A_{c}, where the second reference plane (RP2) is substantially coplanar with the an extent of the first surface 132 or the first taper surface 146. The sunken portions 126 of said radial beams 110 are configured to aid in the off-axis rejection of loads due to being near (but not at) the neutral plane (NP). The shape of the sunken portion 126 can be any shape that provides the structural and/or recessed properties required for the specified actuator. For example, the shape of the sunken portion 126 can be substantially trapezoidal or that of a different polygon. In other embodiments, the sunken portion 126 can be equally shaped and recessed on opposing sides of the beams 110. In further embodiments, the sunken portion 126 may have a cylindrical configuration that extends completely around the inner hub 106.

As shown in the cross-section in FIG. 10, the support section 142 of the radial beam 110 includes a tapered section 144 that extends with a decreasing thickness from the transition portion 120 of the inner hub 106 to the outer rim 108. The first taper surface 146 is substantially parallel to the second horizontal reference plane (RP2) of the flexure element 102 and the second surface 148 is inclined at a taper angle (α) relative to the first taper surface 146 and the second horizontal reference plane (RP2). For example, the thickness of the tapered section 144 of the beam 110 at the intersection of the beam 110 and the transition portion 120 is about 4.8 mm to 7.2 mm, preferably 5.4 mm to 6.6 mm (about 46.4% of the mounting portion thickness), which tapers to a thickness of about 3.3 mm to about 4.9 mm, preferably about 3.7 mm to about 4.5 mm (about 31.7% of the mounting portion thickness), at the outer rim 108. For example, the second surface 130 of the flexure element 102 may have a taper angle (α) of about 3 degrees to 11 degrees, preferably about 5.6 degrees to about 8.4 degrees, with respect to the plane perpendicular to the central axis (A_{c}) of the torque cell 100.

As shown in the cross-section in FIG. 11 (where the section plane cuts through the sunken portion 126 of the radial beam 110) and its zoomed companion view in FIG. 9, the sunken portion 126 is formed in the tapered section 144 of the beam 110. The sunken portion 126 has a curvilinear surface 128 recessed from the first surface 132. The sunken portion 126 includes a planar gauge surface portion 152 surrounded by a contoured region 154. The planar gauge surface portion 152 of each beam 110 is substantially centered on a central radial line or midline that symmetrically divides the beam 110, and the contoured region 154 provides a substantially smooth transition between the planar gauge portion 152 and the first surface 132. The planar gauge portion 152 of each beam 110 is configured to reside in a first reference plane (RP1) parallel to the second reference plane (RP2) to provide a substrate to affix strain gauges 310 of the sensor assembly 300. An inner measurement reference plane (CRP-Mi) and an outer measurement reference plane (CRP-Mo) further define the planar gauge surface portion 152. The contoured region 154 includes an inner curved surface 156 adjacent to the projection portion 116, an outer curved surface 158 adjacent to the outer rim 108, and side transition surfaces 160 forming a transition therebetween. As shown in FIG. 9, the contoured region 154 is defined between the third cylindrical reference plane (CRP3) and the fourth cylindrical reference plane (CRP4). The inner curved surface 156 is defined between the third cylindrical reference plane (CRP3) and the inner measurement reference plane (CRP-Mi) , the planar gauge surface portion 152 is defined between the inner measurement reference plane (CRP-Mi) and the outer measurement reference plane (CRP-Mo) , and the outer curved surface 158 is defined between the outer measurement reference plane (CRP-Mo) and the fourth cylindrical reference plane (CRP4) .

The sunken portion 126 of the beam 110 is formed into the first surface 132 of the flexure element 102 within the thickness of the beam 110. For example, the thinnest portion of the beam 110 at the sunken portion 126 can be about 0.7 mm to 1.1 mm, preferably about 0.8 mm to 1.0 mm (about 6.7% of the inner ring thickness). The depth of the sunken portion 126 can be about 2.9 mm to about 4.3 mm, preferably about 3.2 mm to 4.0 mm. In particular, the planar gauge portion 152 of the recessed surface can be recessed about 2.9 mm to about 4.3 mm, preferably 3.2 mm to about 4.0 mm from the first surface 132. The planar gauge portion 152 can have a radial width at the midline of the beam of about 5.7 mm to about 8.6 mm, preferably about 6.4 mm to 7.9 mm, or about 37% to about 55% of the width of the sunken portion. The inner curved surface 156 adjacent to the projection portion 116 can have a radial width at the midline of the beam of about 3.9 mm to about 5.9 mm, preferably about 4.4 mm to 5.4 mm, or about 25% to about 38% of the width of the sunken portion. The outer curved surface 158 adjacent to the outer rim 108 can have a radial width at the midline of the beam of about 2.4 mm to about 3.6 mm, preferably about 2.7 mm to 3.3 mm, or about 16% to about 24% of the width of the sunken portion. The thickness variations of the flexure element 102 and housing 240 are further illustrated by the color-coded scale in FIGS. 13-14, where the array of different colors represent the various thicknesses of the flexure element 102 and housing 240. Although the illustrative embodiment shows one example of the flexure element 102 of the torque cell 100, the concepts described herein can be relied upon for different configurations and sizes of torque cells.

As described above, FEA may be used to determine the number of beams, shape, arrangement, thickness, material, etc. Also, as noted above, this Application contemplates multiple other beam designs and configurations. For example, the flexure element 102 can include 2 to 50 radial beams, preferably between 3 and 18, and most preferably between 4 and 8. The geometry and configuration of the beams 110 can be optimized for specific torque ranges and the number of beams 110 can be adjusted based on actuator requirements. The beams 110 can be configured with calculated or predetermined beam thicknesses that affect the stiffness and strain sensitivity. Similarly, the beam width influences load capacity and natural frequency. Although more beams increase stiffness and load capacity, sensitivity may be reduced. In some embodiments, special features can be added for mounting or interfacing with actuator components. Further, in some embodiments, the beams can include a first set of beams that include the sunken portion and a second set of interspersed beams that do not include a sunken portion.

### iv.Separation Portions

As shown in at least FIGS. 6, 7 and 14, the flexure element 102 can include separation portions 170 defined between the radial beams 110. Each separation portion 170 may include one or more opening(s) 114, wherein an extent of said opening may abut a beam reference plane (BP1-BP4) to at least partially define the adjacent radial beams 110. For example, separation portions 170a, 170b are defined between BP4 and BP1 and separation portions 170c, 170d are defined between BP2 and BP3. In an illustrative example, radial beams 110 are arranged such that a radial midline of each radial beam is defined along midline planes (MLP1, MLP2) at 90 degrees with respect to each other (FIG. 6), with the separation portions 170 interspersed with the radial beams 110. In other embodiments, the one or more opening(s) 114 may be omitted.

The separation portions 170 also can include: (i) an inner framing portions 172, defined between BP4 and BP1 reference planes for separation portions 170a, 170b and between BP2 and BP3 reference planes for separation portions 170c, 170d, that extend radially outward from the inner hub 106 to openings 114a-114d, and (ii) outer framing portions 112, defined between BP4 and BP1 reference planes for separation portions 170a, 170b and between BP2 and BP3 reference planes for separation portions 170c, 170d, that extend radially inward from the outer rim 108 to the openings 114a-114d. The combination of the inner framing portions 172 and outer framing portions 112 can at least partially define the shape of the opening 114, which features an irregular curvilinear periphery. The configuration of the inner and outer framing portions 172, 112 and the opening 114 can be collectively adjusted to tune and/or improve the stiffness or strength of the flexure element 102.

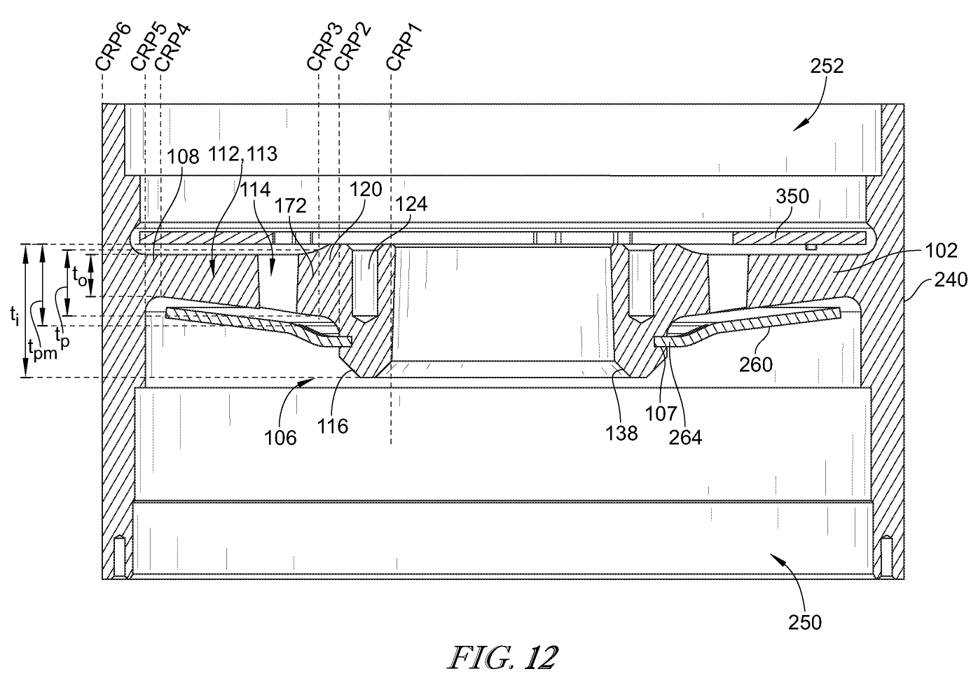

The outer framing portions 112 include an inwardly directed protrusion 113 that bisects the opening 114 and that extends radially inward from the outer rim 108 towards the inner hub 106 and can provide support and/or mounting features for the sensor assembly 300. As shown in the cross-sectional view of FIG. 12, the outer framing portions 112 of the illustrative example are configured to follow substantially the same taper in thickness as the beams 110. As shown in FIGS. 3, 6-7, and 11-12 the outer framing portions 112 extend radially inward from the outer rim 108 into through openings that form the separation openings 114 around the outer framing portions 112. These openings 114 reduce the overall weight of the flexure element 102, while the outer framing portions 112 improve the stiffness of the flexure element 102. In other embodiments, the outer framing portions 112 are used for mounting and do not have structural significance. In further embodiments, the separation portions 170 may be omitted.

### b.Sensor Assembly

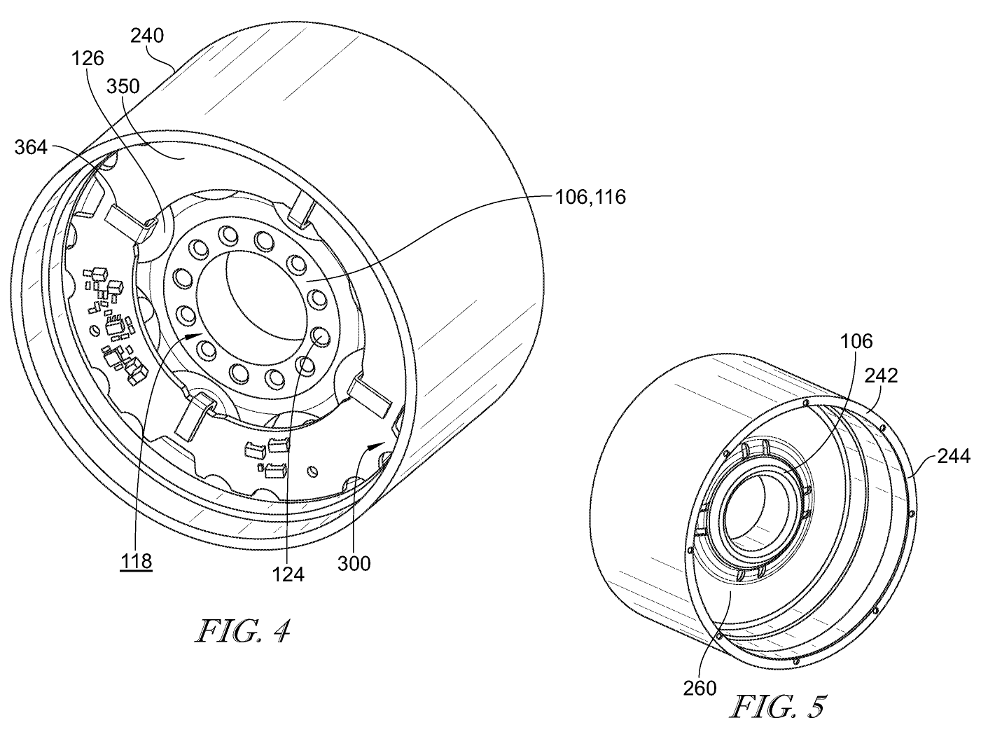

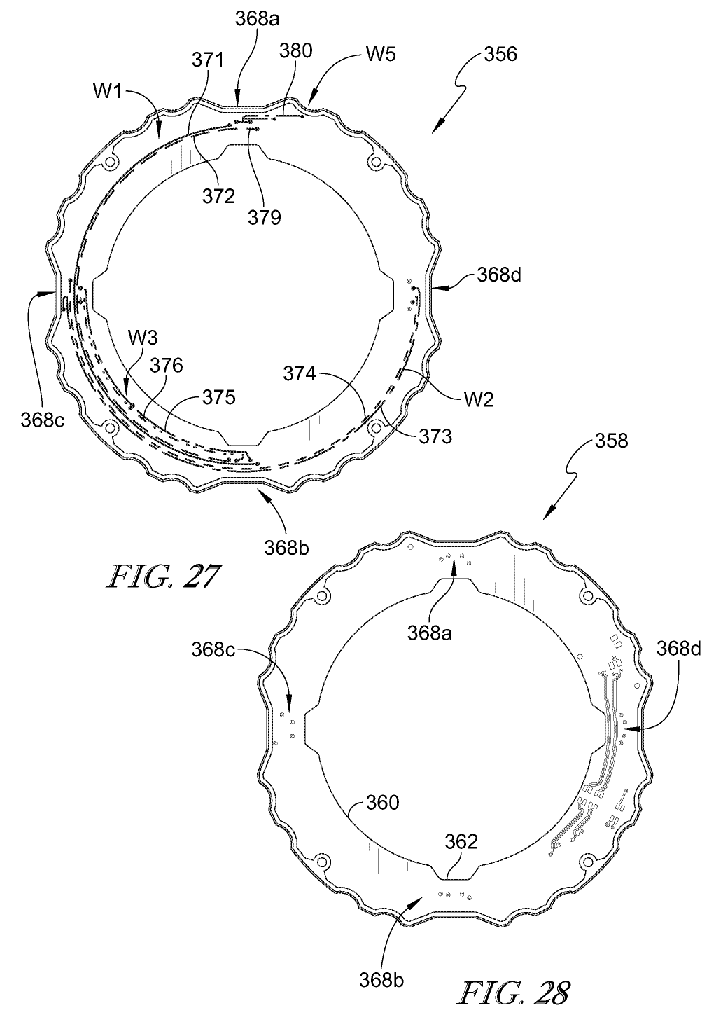

Referring to FIGS. 3, 4, and 19-28, the sensor assembly 300 includes an arrangement of strain gauges 310 applied to the flexure element 102 and a measurement circuit 340 coupled to the strain gauges 310. For example, the measurement circuit 340 can be embodied in a sensor board 350 as shown in FIGS. 3-4, where the strain gauges 310 are coupled to a sensor board 350 with coupling tabs or conductive couplers 364. A strain gauge 310 is a sensor whose resistance varies with applied force. It converts force, pressure, tension, weight, etc., into a change in electrical resistance which can then be measured. The measurement circuit 340 converts the detected electrical resistance values to torque measurements to be utilized by computing systems of the robot 1. The sensor assembly 300 is configured to detect and measure applied torque to accurately produce controlled torque outputs of the actuator, despite motor and gear train friction, inertia, and other effects.

The sensor assembly 300 can be configured to fit within the housing 240. The sensor assembly 300 can couple with the torque cell 100 at a ledge or groove 248 formed in the housing sidewall 242. The individual strain gauges 310 are arranged on the beams 110 of the flexure element 102 at 45-degree angles to the axis of rotation. As shown in FIG. 11, the planar gauge portion 152 of the recessed surface 128 on each beam 110 of the flexure element 102 is configured such that the individual strain gauges 310 can be arranged in a strain gauge layer 302 that is parallel to the second reference plane RP2 that extends perpendicular to the center axis A_{c}.

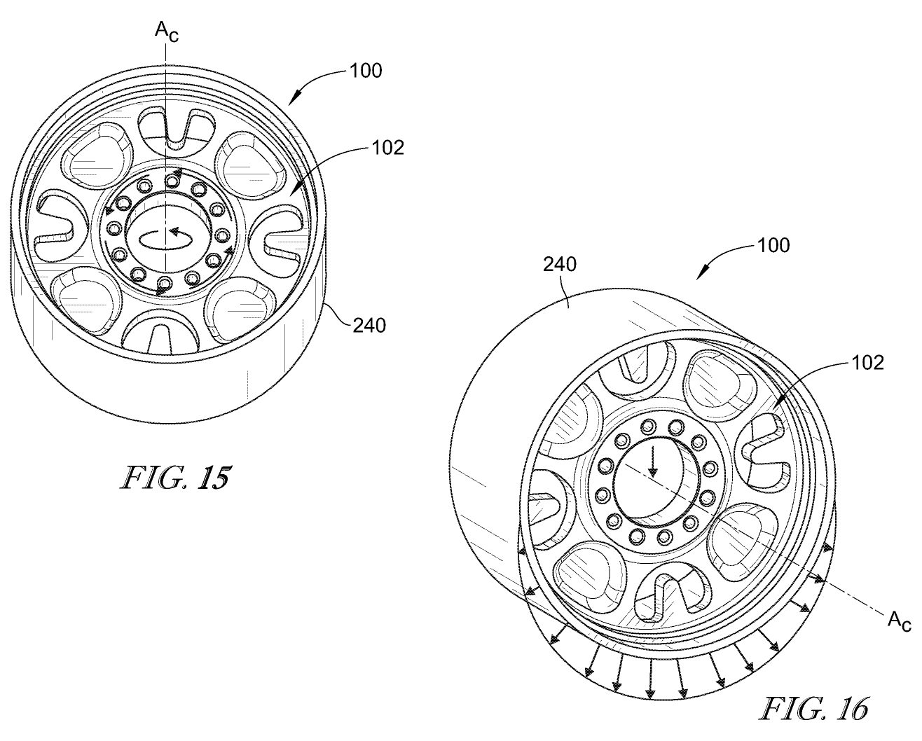

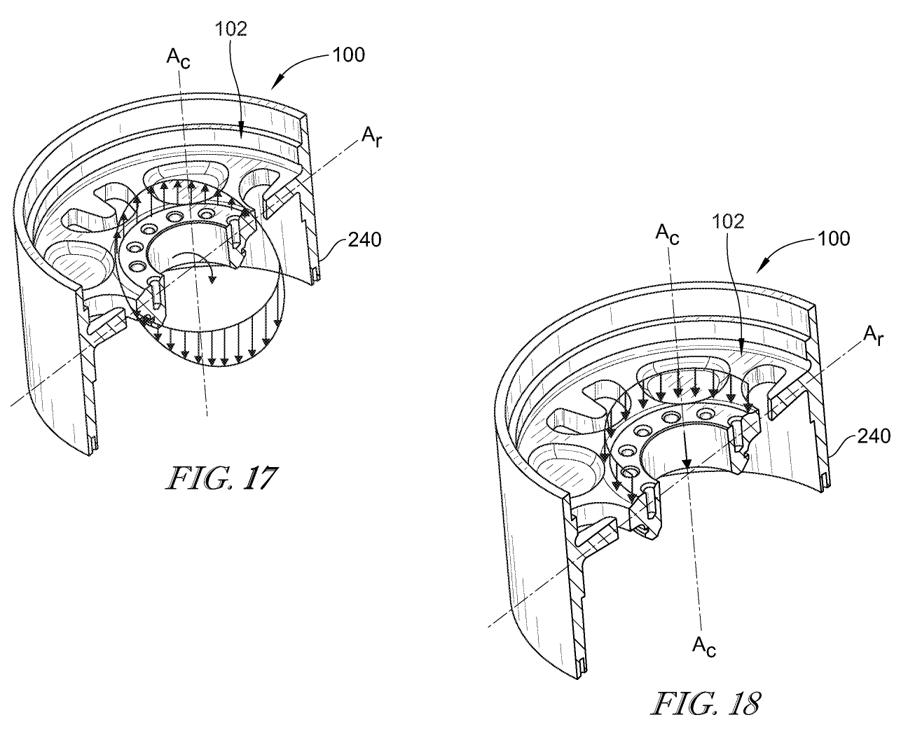

The torque cell 100 can be subject to internal and external applied loads (force and moment) in three-dimensional space during operation of the humanoid robot 1. For accurate torque measurements, it is desirable to only measure rotational torque about a single on-axis (central axis) while not measuring all force measurements and torque measurements of the off-axes. Unfortunately, the off-axis torques and forces are often coupled to a single axis torque measurement reading since the off-axis torques and forces can typically produce a strain also measured by the strain gauges 310. As illustrated with arrows in FIGS. 15-18, examples of applied loads can include torque loads, moment or bending loads, axial loads, and radial loads. Shown as a counter-clockwise moment about a central axis in FIG. 15, the flexure element 102 may be subjected to torque of the actuator motor or external loads applied to the housing 240 coupled to the outer rim 108. As illustrated in FIG. 16, when a radial load is applied at the central axis the force is distributed radially. In FIG. 17, a counter-clockwise moment about a reference axis (A_{R}) perpendicular to the central axis applies a bending or moment load. In FIG. 18, an axial load is applied in the same direction as the central axis (A_{c}). While the actuator housing 240, and therefore the reaction-type torque cell 100, will be subjected to the radial load (FIG. 16), the moment load (FIG. 17), and the axial load (FIG. 18), the overall design and configuration of the reaction-type torque cell 100 sufficiently rejects these undesirable loads and isolates the rotational load (FIG. 15) for measurement and use by the robot 1.

### i.Strain Gauge Arrangement

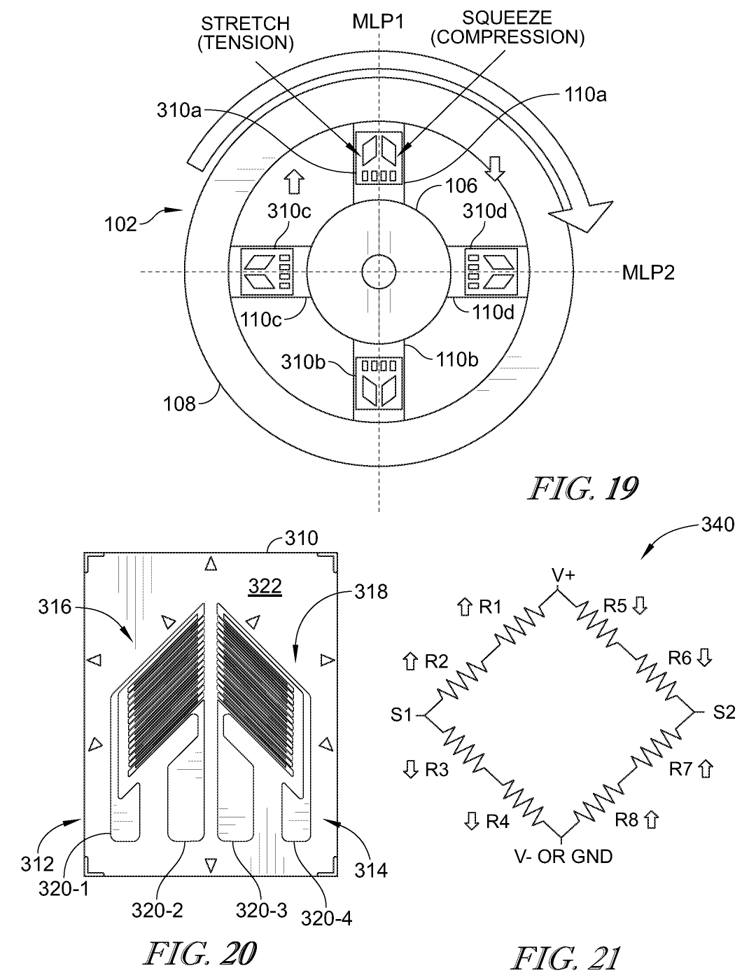

A sensor assembly 300 includes a plurality of strain gauges 310 applied directly to the flexure element 102 and a measurement circuit 340 coupled to the strain gauges 310. As illustrated in FIGS. 4 and 19, the sensor assembly 300 can include a sensor board 350 that includes the measurement circuit 340 among other components of an electronic package. Each strain gauge 310 includes a first resistance gauge element 312 and a second resistance gauge element 314. The strain gauges 310 can be made of a thin metallic foil (e.g., constantan) or semiconductor material and arranged with an active grid area 316, 318 in a grid or zigzag pattern to maximize sensitivity to strain in a specific direction. The strain gauge 310 can include a backing material 322 for easy handling and application. For example, as illustrated in FIG. 20, the first resistance gauge element 312 can have an active grid area 316 in a first 45° direction and the second resistance gauge element 314 can have an active grid area 318 in a second 45° direction that is perpendicular to the first 45° direction.

A simplified diagram of the flexure element 102 is shown in FIG. 19 with an arrangement of the plurality of strain gauges 310. In this example, a first strain gauge 310a is affixed to a first beam 110a, a second strain gauge 310b is affixed to a second beam 110b extending opposite the first beam 110a, a third strain gauge 310c is affixed to a third beam 110c, and a fourth strain gauge 310d affixed to a fourth beam 110d extending opposite the third beam 110c. Each strain gauge 310a-310d can be affixed to a beam 110 of a plurality of beams of a flexure element 102 such that the first resistance gauge element 312 and the second resistance gauge element 314 of each strain gauge 310 are arranged symmetrically about a radial midline of said beam 110 that symmetrically divides the beam 110. The individual strain gauges 310 can be arranged on the gauge surface portion 152 in a strain gauge layer 302 in the first reference plane RP1 that extends perpendicular to the center axis. The plurality of strain gauges 310 applied to the beams 110 of the flexure element 102 are coupled to a sensor board 350 with conductive couplers 364. The sensor assembly 300 can be communicatively coupled to a computing device of the robot 1 to process the load information detected. In some embodiments, the strain gauge layer 302 can be bonded to the recessed surface 128 of each beam 110 using an adhesive or any other known means. Prior to bonding said strain gauge layer 302 to the recessed surface 128, any surface finishing process may be used on the recessed surface 128 to prepare the bonding of the strain gauge layer 302 to the recessed surface 128; said finishing process may include any one or any combination of laser etching, machining, sanding, and/or polishing. In addition, said finishing process may provide alignment guides for the strain gauge layer 302 and/or said strain gauge layer 302 may be coupled to the flexure element 102 using a computer aided process.

For example, as shown in FIG. 19, the strain gauges 310a-310d can be arranged on the individual beams 110a-110d. In this example, the strain gauges 310 are double element strain gauges symmetric to a radial midline of the beam, where a first resistance gauge element 312 has an active grid area 316 arranged at -45 degrees on the left side of the midline and a second resistance gauge element 314 has an active grid area 318 arranged at +45 degrees on the right side of the midline. Each strain gauge 310 is positioned on each radial beam 110 at the same radial position with the same orientation. In the illustrative example, the strain gauges 310 are applied to the gauge surface portion 152 of a recessed surface 128 of the individual beams 110. Although a double element strain gauge is shown, other types of strain gauges can be relied on and positioned with active grid areas arranged at -45 degrees and +45 degrees.

### ii.Measurement Circuit

The measurement circuit 340 can include the individual resistance gauge elements 312, 314 of the strain gauges 310 acting as variable resistors (R), a voltage source (V+) 342, a ground (GND) 344, a first signal output (S1) 346, and a second signal output (S2) 348. In various embodiments, the sensor assembly 300 can also include a processor and an analog to digital converter. The measurement circuit 340 can be arranged in a Wheatstone bridge configuration as described below with a wiring arrangement to help minimize the effects of EMI.

As shown in FIG. 19, when an inner hub 106 is loaded in torsion, it creates a state of pure shear and the applied torque can be found by orienting the strain gauges where gridlines are positioned at 45 degrees to an axis of a shaft. The resistance gauge elements 312, 314 of the strain gauges 310 sense the normal-strain exposed on a surface of a radial beam 110 and act as resistors in an electrical circuit. As illustrated, each strain gauge 310a-310d is a same type of strain gauge and the annotation to represent a variable resistor (R) is to illustrate the order of wiring in a measurement circuit 340 shown in FIG. 21. For example, four strain gauges 310a-310d can be used, each having first and second resistance gauge elements 312a-312d, 314a-314d, represented as R1-R8. For example, strain gauge 310a includes resistance gauge elements 312a, 314a labeled R1, R5; strain gauge 310b includes resistance gauge elements 312b, 314b labeled R8, R4; strain gauge 310c includes resistance gauge elements 312c, 314c labeled R2, R3; and strain gauge 310d includes resistance gauge elements 312d, 314d labeled R7, R6.

With the illustrated clockwise torque applied in FIG. 19, each of the first resistance gauge elements 312a-312d (e.g., labeled: R1, R2, R7, R8) detect tension and each of the second resistance gauge elements 314a-314d (e.g., labeled: R3, R4, R5, R6) detect compression. This arrangement maximizes sensitivity to torsional strain while minimizing the effects of bending or axial loads. This configuration provides increased sensitivity, temperature compensation, and cancellation of effects from non-torsional strains. As shown in FIG. 21 as a schematic diagram, the eight resistance gauge elements (R1-R8) of FIG. 19 can be wired in a Wheatstone bridge circuit where the four legs can each have two sequentially connected resistance gauge elements (R1-R8). For example, shown in the Wheatstone bridge, a first leg can include R1 and R2, a second leg can include R5 and R6, a third leg can include R7 and R8, and a fourth leg can include R3 and R4, where the first leg is opposite the third leg, and the second leg is opposite the fourth leg. In this example of clockwise torque, the first leg (R1, R2) and opposing third leg (R7, R8) detect tension, and the fourth leg (R3, R4) and opposing second leg (R5, R6) detect compression.

When the actuator is in operation, torque is applied to the flexible externally-toothed gear coupled to the flexure element 102. The torque from the flexible externally-toothed gear is then transferred to the inner hub 106 of the flexure element 102, which causes a slight twist in the flexure element 102. This twist creates tensile strain in the first resistance gauge elements 312 and compressive strain in the second resistance gauge elements 314 of the strain gauges. The strain causes a change in the electrical resistance of each strain gauge, where tension increases resistance and compression decreases resistance. These resistance changes unbalance the Wheatstone bridge. When an excitation voltage is applied to the Wheatstone bridge, the unbalanced bridge produces a small voltage output. This output voltage is directly proportional to the applied torque.

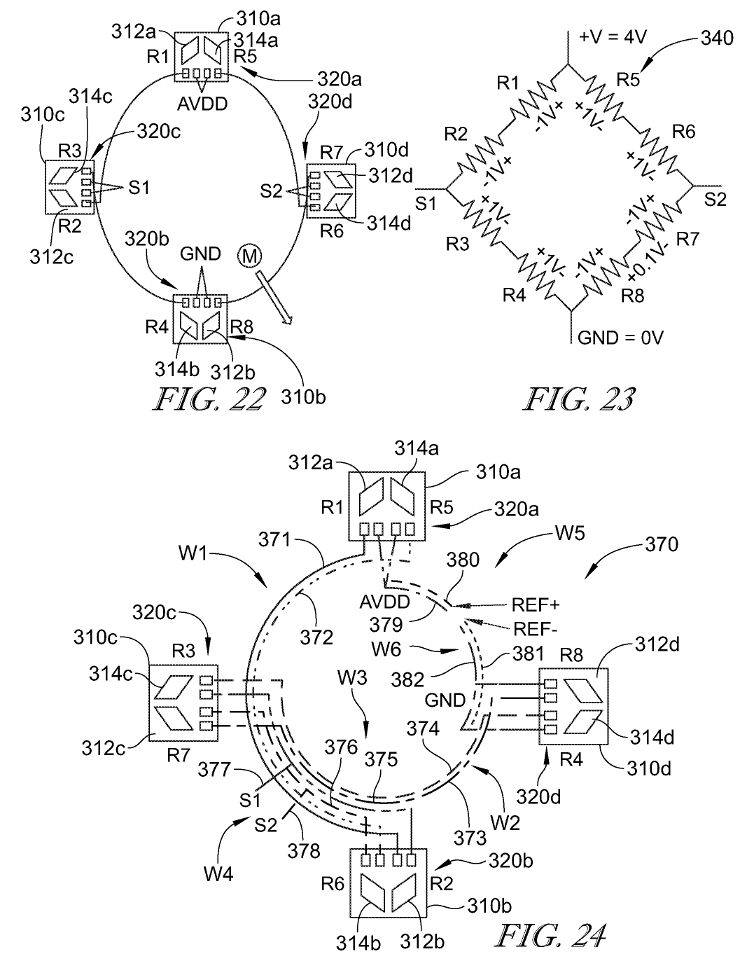

FIG. 22 illustrates a simple wiring arrangement in the shortest paths between strain gauges 310a-310d to implement the Wheatstone bridge of FIG. 21. However, the single wiring connections between strain gauges are susceptible to magnetic forces, which may result in false measurements. The circle and arrow illustrate a magnetic field moving over, perpendicular to, and across the wiring between R7 and R8. With reference to FIG. 23, this moving magnetic field would temporarily induce a voltage across the trace wiring as shown as +0.1v- between R7 and R8. The moving magnetic field would induce a current in the wire that is proportional to the magnetic field strength on the wiring, which is proportional to the magnet field strength and magnet distance from the wiring and the magnet velocity. The induced current generates a voltage in the Wheatstone bridge. Since the strain gauge voltage signals are normally very small, an amplifier can be used to increase the strain gauge voltage signals. Strong magnetic fields, such as those found in powerful electric motors used in compact actuators, can move in close proximity to the strain gauge and would induce a voltage. In the example shown, S1-S2 = 2v–1.9v = 0.1v that would be interpreted as a torque measurement even though no torque is being applied to the torque cell. Thus, the +0.1v between R7 and R8 could affect the strain gauge voltage output signals resulting in inaccurate torque measurements.

### iii.Wiring Arrangement

As shown in FIG. 24, the wiring paths of the strain gauges 310a-310d can be rearranged to minimize the effect of magnetic forces on the measurement circuit 340 (FIG. 21). In the illustrative embodiment, the same four strain gauges 310a-310d of FIG. 19 can be used; however, first and second resistance gauge elements 312a-312d, 314a-314d are reassigned to new positions representing R1-R8 of the measurement circuit 340 shown in FIG. 21. For example, in FIG. 24, strain gauge 310a includes resistance gauge elements 312a, 314a labeled R1, R5; strain gauge 310b includes resistance gauge elements 312b, 314b labeled R2, R6; strain gauge 310c includes resistance gauge elements 312c, 314c labeled R7, R3; and strain gauge 310d includes resistance gauge elements 312d, 314d labeled R8, R4. Even though the positions have been reassigned, with clockwise applied torque, each of the first resistance gauge elements 312a-312d (e.g., labeled: R1, R2, R7, R8) detect tension and each of the second resistance gauge elements 314a-314d (e.g., labeled: R3, R4, R5, R6) detect compression.

The wiring diagram in FIG. 24 shows a wiring arrangement 370 to implement the measurement circuit 340 (FIG. 21), where different dashed lines indicate different paths. The wiring arrangement includes a plurality of wiring pairs, each wiring pair arranged parallel to each other and in a substantially arcuate path along a radial position. Although the wiring paths are longer, the pairs of parallel wires reduce an effect of magnetic forces on the circuit. In this context, a first wiring pair (W1) connects the first strain gauge 310a to the second strain gauge 310b. Specifically, the first wiring pair (W1) includes a first wire path 371 connecting first resistance gauge elements 312a and 312b (R1-R2) and a second wire path 372 connecting second resistance gauge elements 314a and 314b (R5-R6). A second wiring pair (W2) connects the third strain gauge 310c to the fourth strain gauge 310d. Specifically, the second wiring pair (W2) includes a third wire path 373 connecting first resistance gauge elements 312c and 312d (R7-R8) and a fourth wire path 374 connecting second resistance gauge elements 314c and 314d (R3-R4).

A third wiring pair (W3) connects the second strain gauge 310b to the third strain gauge 310c. Specifically, the third wiring pair (W3) includes a fifth wire path 375 connecting first resistance gauge element 312b and second resistance gauge element 314c (R2-R3) and a sixth wire path 376 connecting second resistance gauge element 314b to first resistance gauge element 312c (R6-R7). A fourth wiring pair (W4) includes a seventh wire path 377 that connects a center point tap of the fifth wire path 375 to the first signal output 346 (S1) and an eighth wire path 378 that connects a center point tap of the sixth wire path 376 to the second signal output 348 (S2). A fifth wiring pair (W5) includes ninth and tenth wire paths 379, 380 to connect the first and second resistance gauge elements 312a, 314a of the first strain gauge 310a to the voltage source 342. A sixth wiring pair (W6) includes eleventh and twelfth wire paths 381, 382 to connect the first and second resistance gauge elements 312d, 314d of the fourth strain gauge 310d to the ground.

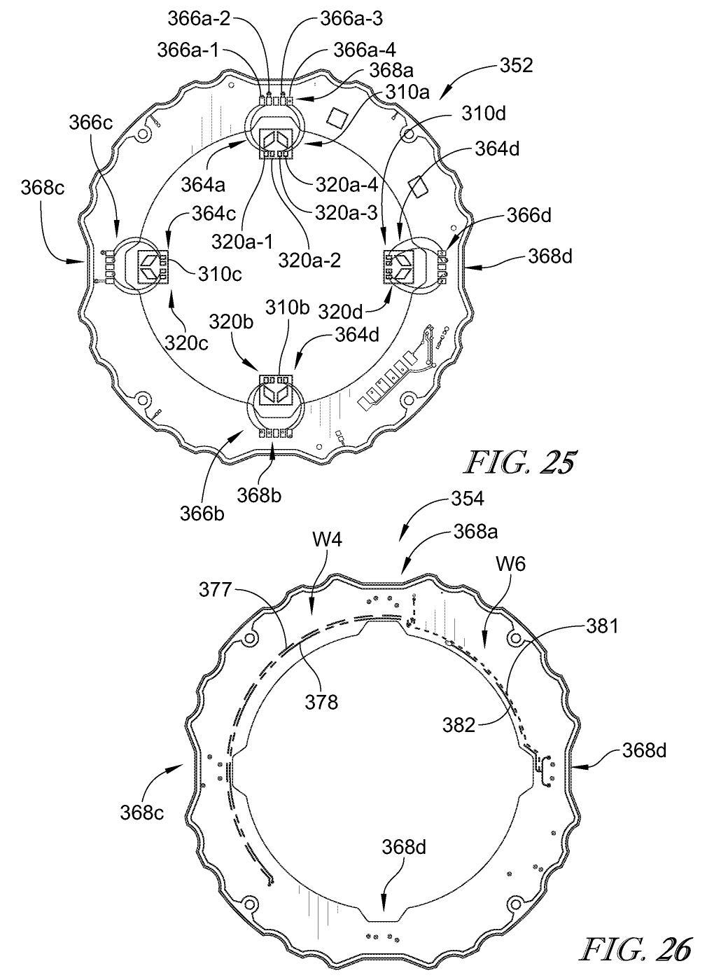

The wiring arrangement 370 can be implemented as a planar wiring structure on one or more layers of a printed circuit board (PCB) assembly, also called a sensor board 350 herein. As shown as a non-limiting example in FIGS. 25-28, the sensor board 350 can include a plurality of layers 352-358 shaped around a center aperture 360 and configured to fit within the housing 240. As shown in FIG. 25, the sensor board 350 can have interior notches 362 to align the wiring contacts 366 on a top interface layer 352 with the strain gauges 310 affixed to the beams 110 of the flexure element 102 to couple the strain gauges 310 to the sensor board 350 using conductive couplers 364. The conductive couplers 364 are configured to provide a set of electrical coupling connections between the leads 320 of the strain gauges 310 to respective wiring contacts 366 on the sensor board 350. For example, the conductive couplers 364 shown schematically in FIG. 25, illustrated with lines representing conductors 365 between the individual leads 320 (e.g., 320a-1, 320a-2, 320a-3, 320a-4) to the respective wiring contacts 366 (e.g., 366a-1, 366a-2, 366a-3, 366a-4) on the top interface layer 352 of the sensor board 350. The conductors 365 of the conductive couplers 364 include conductive paths in a flexible PCB or wire (e.g., individual wires, ribbon cable, etc.). The top interface layer 352 can include connections to a voltage source 342, a ground 344, a first signal output (S1) 346, and a second signal output (S2) 348. The top interface layer 352 can also include a processor and an analog to digital converter.

The top interface layer 352 is shown relative to the strain gauges as positioned in FIG. 19. As can be understood, when implemented, the strain gauges 310a-310d can be positioned with a substantial extent beneath the sensor board 350 to connect via the conductive couplers 364. The layers 352-358 include sets of vias 368a-368d that allow the conductive wiring paths to continue through the layers, as needed. The first and second wiring layers 354, 356 can include the planar wiring structure of FIG. 24. In an illustrated embodiment, the fourth wiring pair (W4) and sixth wiring pair (W6) are shown on the first wiring layer 354 The first-third wiring pairs (W1, W2, W3) and the fifth wiring pair (W5) are shown on the second wiring layer 356 Although one example of the wiring arrangement 370 is shown on layers 354, 356, other arrangements of the wiring pairs (W1-W6) on one or more layers can be relied on. For example, layer 354 can include wiring pairs (W1, W2, W3, W5, W6) and layer 356 can include only W4. It may also be possible to implement the wiring arrangement in one layer by repositioning the output connection on the top interface layer 352 or spread one or more of the wiring pairs (W1-W6) over a plurality of layers. The bottom interface layer 358 can include an interface for other electronic components and/or connections. Although only four layers are shown in this example, the sensor board 350 can include other layers not discussed herein.

The sensor assembly 300 can be calibrated to ensure accurate measurements. For calibration, the torque cell 100 can be subjected to known torques across its operating range. The voltage output is then recorded for each applied torque. A calibration curve can be generated, relating voltage output to torque. This calibration curve can be used in signal processing to convert voltage to torque units (e.g., N-m or ft-lbs). The sensor assembly 300 can also include signal conditioning electronics for amplification, filtering, and conversion. The signal can also be filtered to remove noise and unwanted frequency components. The signal can be converted from analog to digital for digital processing and interface with control systems. Additionally, the detected small voltage signal can be amplified, using instrumentation amplifiers. The processed torque signal enables: closed-loop torque control, torque limiting for safety and overload protection, and performance monitoring and diagnostics.

### c.Protective Shield

As best shown in FIGS. 3, 5, and 8-10 the protective shield 260 is configured to be coupled to the flexure element 102 at the mounting portion 116 of the inner hub 106 and extends over the second surface 130 of the flexure element 102 to the outer rim 108. The protective shield 260 can have a disc-like shape with a central aperture 262 and an external diameter that substantially matches the interior diameter of the outer rim 108. In various embodiments, the external diameter of the protective shield 260 can extend over at least a portion of the outer rim 108 or can substantially match the interior diameter of the interior portion 244 of the housing 240 into which it will be installed. The protective shield 260 can include means of attachment to the inner hub 106. As shown in FIG. 3, the illustrative embodiment includes a shield mounting portion 266 about the central aperture 262 having regularly spaced tabs 264 configured to snap into a slot or mounting groove 107 formed about the mounting portion 116 of the inner hub 106. In some examples, the protective shield 260 can be further secured in place using clips 268. As shown in FIGS. 10-12, although the protective shield 260 is coupled to the torque cell 100 at an engagement projection 138 of the inner hub 106, the protective shield 260 is spaced apart from the second surface 130 of the flexure element 102; thus the flexure element 102 moves independently from the shield 260. The protective shield 260 does not interfere with deformation of the radial beams 110 or measurement of the associated loads applied to the flexure element 102. As shown in the figures, the shield 260 may be configured to substantially conform with the taper of the second surface 130 of the flexure element 102, which has a taper angle (α) of about 5.6 degrees to about 8.4 degrees, with respect to the reference plane RP2 of the flexure element 102.

The protective shield 260 is configured to reduce EMI noise from the motor or other mechanical components. The shield 260 can be made from conductive fabric, conductive coatings, composite materials, specialized shielding materials, hybrid solutions, EMI absorption materials, and combinations thereof. For example, conductive fabric can include silver-coated nylon, copper-coated polyester, nickel-copper fabric, etc. Conductive coatings can include silver paint, copper paint, nickel paint, graphite coatings, etc. Composite materials can include carbon fiber composites, metal-filled plastics (e.g., copper-filled ABS), etc. Specialized shielding materials can include ferrite sheets or tiles, metalized films (e.g., aluminized Mylar), conductive elastomers (e.g., silicone with metal particles), etc. Hybrid solutions can include laminated shielding (e.g., combinations of different materials, foam cores with conductive outer layers, etc.). EMI absorption materials can include ferrite-based absorbers, carbon-loaded absorbers, etc. It should be understood that the protective shield may be integrally formed with the motor and/or may be omitted in certain embodiments.

### D.Alternative Embodiments

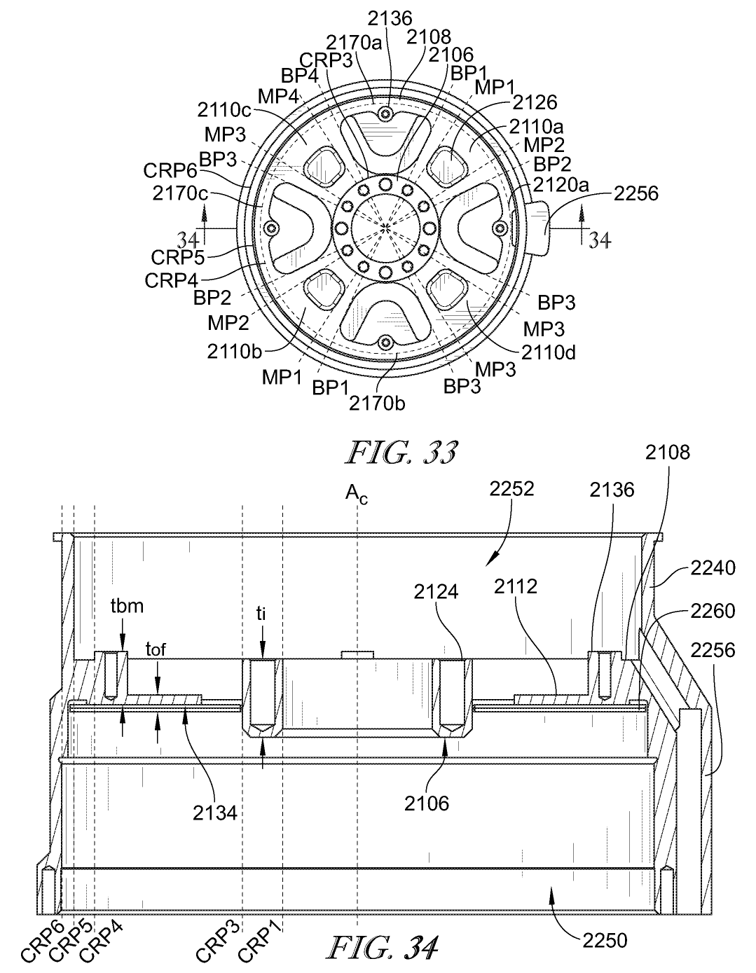

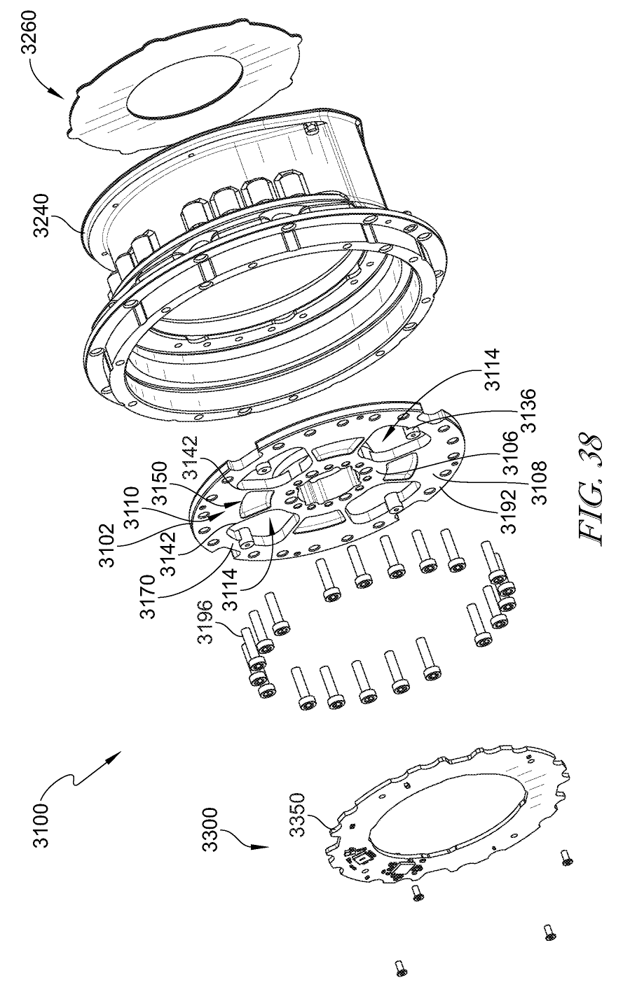

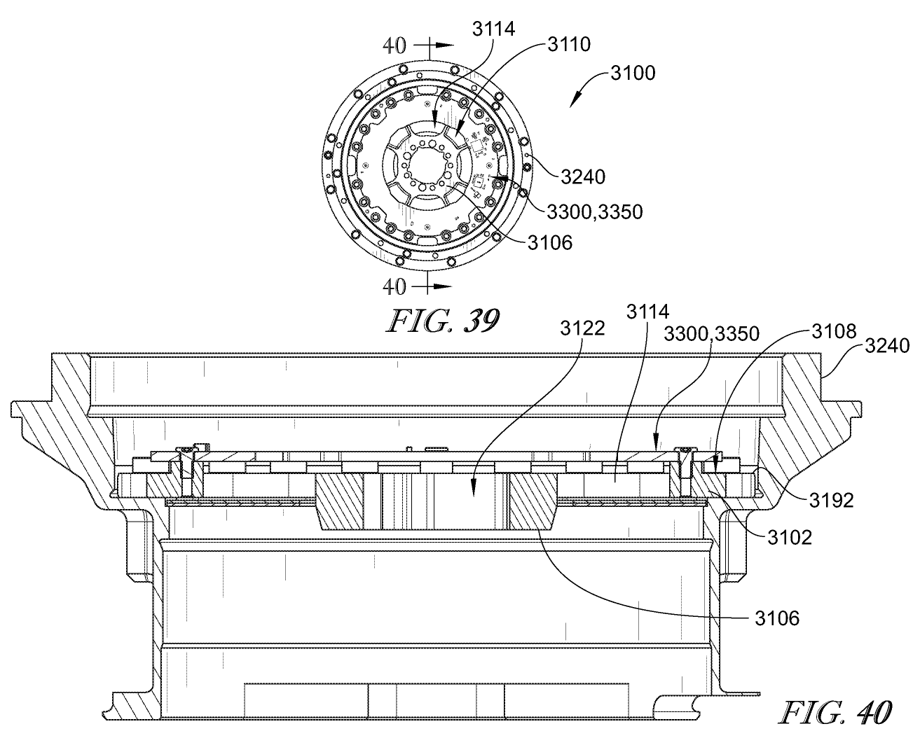

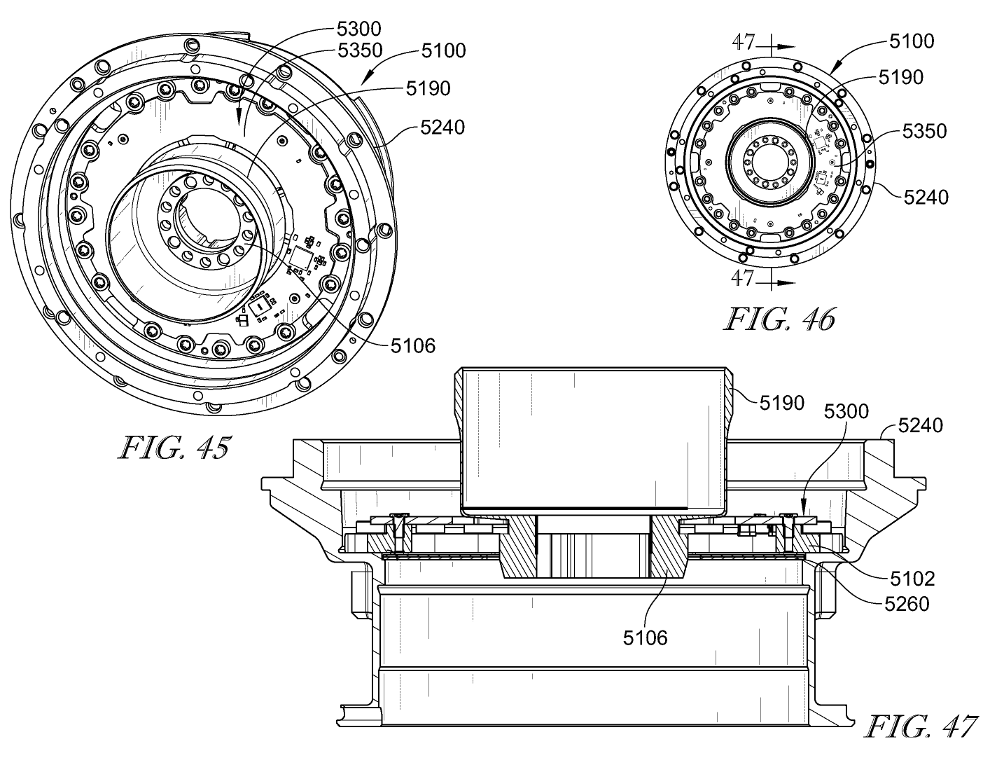

Alternative embodiments of the illustrative torque cell 100 that illustrate alternative torque cell configurations 1100, 2100, 3100, 4100, and 5100 are shown in FIGS. 28-47. Various embodiments of the flexure element are shown with cooperating actuator housing structures. Torque cells 3100, 5100 show embodiments of the flexure elements 3102, 5102 manufactured separately to be coupled to the housing 3240, 5240. Although not explicitly shown, it can be understood that embodiments of flexure elements 100, 1100, 2100, 4100 shown as integrated with a housing sidewall can be modified to include an outer mounting portion 192 (e.g., mounting ring or other mounting projections) instead of the housing and be separately coupled to an actuator housing with fasteners in a manner similar to torque cells 3100, 5100. Similarly, flexure elements 3102, 5102 can be modified to integrate the outer mounting portion into the actuator housing. The sensor assembly 300 described herein can be modified for use with the alternative torque cell embodiments or variations thereof.

### a.Second Embodiment

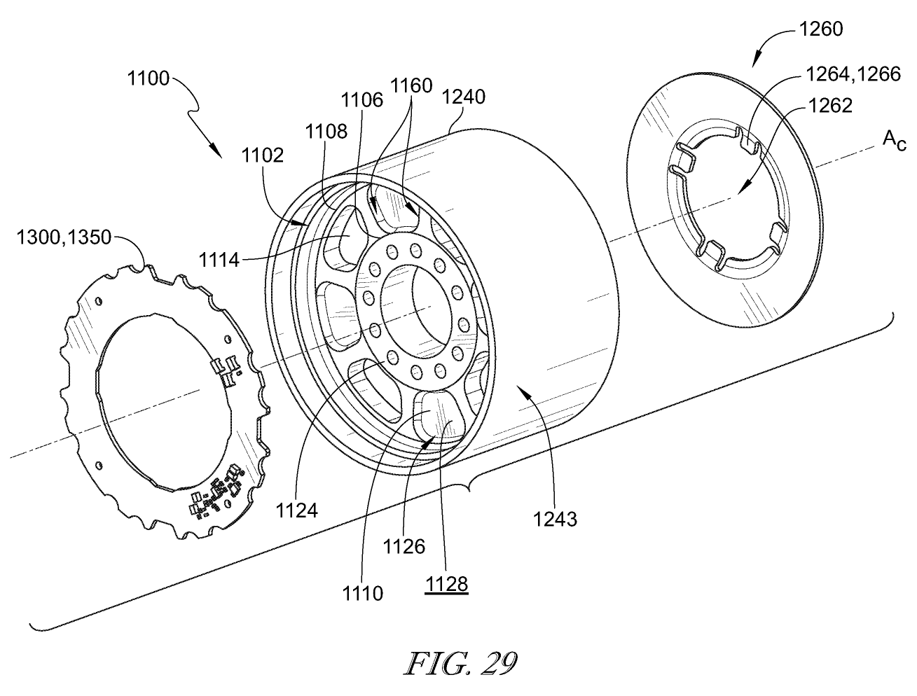

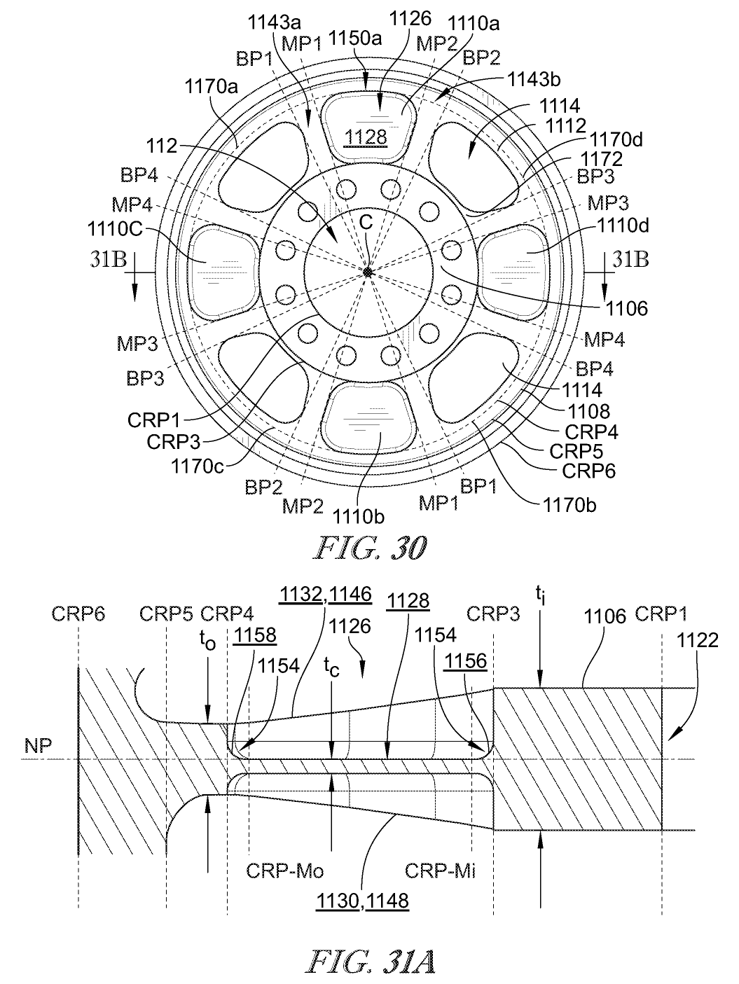

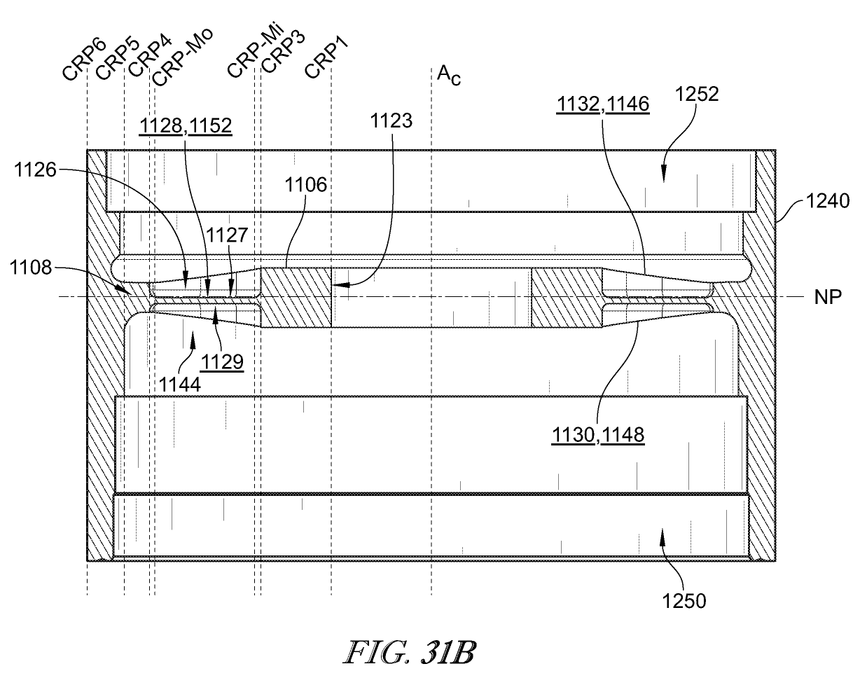

Shown in FIGS. 29-31 as a second embodiment, torque cell 1100 includes an alternative flexure element 1102 integrally formed with housing 1240. For sake of brevity, the above disclosure in connection with flexure element 102 will not be repeated below, but it should be understood that across embodiments like numbers represent like structures. In this embodiment, the flexure element 1102 includes a radial beam 1110 having first and second surfaces 1132, 1130, that both taper from a greater thickness at the inner hub 1106 to a reduced thickness at the outer rim 1108. The tapered thickness helps normalize the loads across the beams 1110. The sunken portion 1126 includes a recessed surface 1128 recessed from the first surface 1132 and additionally a cooperating recessed surface 1129 recessed from the second surface 1130 or taper surface 1148. The recessed surface 1128 includes at least a gauge surface portion 1152 that resides substantially within the neutral plane of the flexure element 1102. As shown in FIG. 30, radial beam planes (BP1-BP4) define the radial beams 1110a-1110d and separation portions 1170a-1170d. The support sections 1142 and a measurement section 1150 of each beam 1110 are further defined by measurement planes (MP1, MP2, MP3, MP4) that extend radially intersecting at a center-point (C). The radial beams 1110 can include: (i) a pair of support sections 1142 including a first section 1143a and a second section 1143b, and (ii) a measurement section 1150. For example, the first beam 1110a includes a first section 1143a-a defined between BP1 reference plane and MP1 reference plane and the second section 1143b-a defined between MP2 reference plane and BP2 reference plane, and a measurement section 1150a is defined between MP1 reference plane and MP2 reference plane, that resides between the support sections 1142. As shown in FIGS. 31A-31B, the radial beams 1110 can have a varying thickness that tapers from the inner hub 1106 (i.e., CRP3) to the outer rim 1108 (i.e., CRP4). The varying thickness is configured to achieve a more uniform strain field in the radial orientation.

Similar to the first embodiment, several reference planes (CRP1, CRP3-CRP6) are indicated to further define the configuration of the flexure element 1102 and its components. In this embodiment, the inner hub 1106 is substantially uniform in thickness, thus a projection portion and the second reference plane (CRP2) are omitted. As shown at least in the cross-sections of FIGS. 31A-31B, a first cylindrical reference plane (CRP1) is defined at a first radius (r₁) about the central axis (A_{c}) at the inner wall 1123 of the inner hub 1106 at the central opening 1122. The third cylindrical reference plane (CRP3) is defined at a third radius (r₃) indicating an innermost radius of the tapered section 1144 at the transition from the inner hub 1106. The fourth cylindrical reference plane (CRP4) is defined at a fourth radius (r₄) indicating an outermost radius of the tapered section 1144. The fifth cylindrical reference plane (CRP5) is defined at a fifth radius (r₅) at the transition between the outer rim 1108 and the housing 1240. The sixth cylindrical reference plane (CRP6) is defined at a sixth radius (r₆) at the exterior surface 1243 of the housing 1240. The third cylindrical reference plane (CRP3) and the fifth cylindrical reference plane (CRP5) are further shown in FIG. 30 as dashed circles.

As shown in FIG. 31B, (where the section plane cuts through the measurement section 1150 of the radial beam 1110) and its zoomed companion view in FIG. 31A, the sunken portion 1126 is formed in the tapered section 1144 of the beam 1110. The sunken portion 1126 has a curvilinear surface 1128 recessed from the first surface 1132 or taper surface 1146. The sunken portion 1126 includes a planar gauge surface portion 1152 surrounded by a contoured region 1154. The planar gauge surface portion 1152 of each beam 1110 is substantially centered on a central radial line or midline that symmetrically divides the beam 1110 and the contoured region 1154 provides a substantially smooth transition between the planar gauge portion 1152 and the first surface 1132. The planar gauge portion 1152 of each beam 1110 is configured to reside in a neutral plane (NP) to provide a substrate to affix strain gauges 1310 of the sensor assembly 1300. The contoured region 1154 includes an inner curved surface 1156 adjacent to the inner hub 1106, an outer curved surface 1158 adjacent to the outer rim 1108, and side transition surfaces 1160 forming a transition therebetween. As shown in FIG. 31A, the contoured region 1154 is defined between the third cylindrical reference plane (CRP3) and CRP4 reference plane. The inner curved surface 1156 is defined between the third cylindrical reference plane (CRP3) and CRP-Mi reference plane, the planar gauge surface portion 1152 is defined between CRP-Mi reference plane and CRP-Mo reference plane, and the outer curved surface 1158 is defined between CRP-Mo reference plane and CRP4 reference plane.

In the illustrative embodiment, the first and second surfaces 1132, 1130 of the beams 1110 can be substantially symmetrical about the neutral plane (NP) forming support sections 1142 of each beam 1110. However, the sunken portion 1126 is configured such that the recessed surfaces 1128, 1129 are formed at different depths from respective surfaces 1132, 1130 providing a thin web 1127 to affix strain gauges in the measurement section 1150. In particular, the sunken portion 1126 is configured such that a gauge surface portion 1152 of the recessed surface 1128 lies within the neutral plane. The recessed surface 1129 is substantially parallel to recessed surface 1128, but offset from the neutral plane, thus asymmetrical. In other words, the beams 1110, including first and second surfaces 1132, 1130, are substantially symmetrical about the neutral plane of the flexure element 1102 in the support section 1142, but asymmetrical about the neutral plane in the measurement section 1150. Although the thickness (tᵣ) of the web 1127 is positioned on one side of the neutral plane, which slightly alters the neutral plane of the flexure element 1102, the height of the surrounding support section 1142 is much greater than the web portion 1127, thus the stiffness of the support section is much greater and the influence of the web offset with respect to the bending stiffness is very small. This results in near-zero strain on the gauge surface portion 1152 for uniformly distributed bending loads.

### b.Third Embodiment

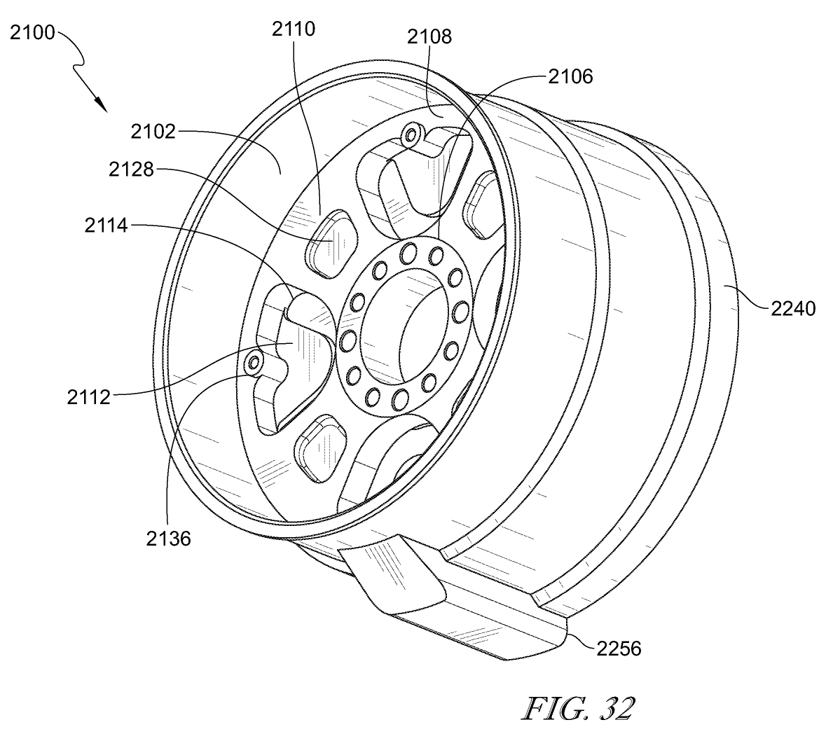

Shown in FIGS. 32-36 as a third embodiment, torque cell 2100 includes an alternative flexure element 2102 integrally formed with housing 2240. In this third embodiment, radial beams 2110 of the alternative flexure element 2102 have first and second surfaces 2132, 2130 that are substantially parallel and the sunken portion 2126 includes a cooperating recessed surface 2129 recessed from the second surface 2130 providing a thinner beam portion to receive the strain gauges. The recessed surfaces 2128, 2129 can be symmetrically formed on opposite sides of the beam 2110. The housing 2240 additionally includes a vent 2256 that provides a ventilation passage from the output side 2252 of the housing 2240 to the exterior. The separation portions 2170 also include outer framing portions 2112 and board mounts 2136 (also called board mounting structures, fastener mounts, or component mounts) positioned adjacent to the outer rim 2108. The board mounts 2136 configured to couple an extent of the sensor assembly 2300 to the flexure element 2102.

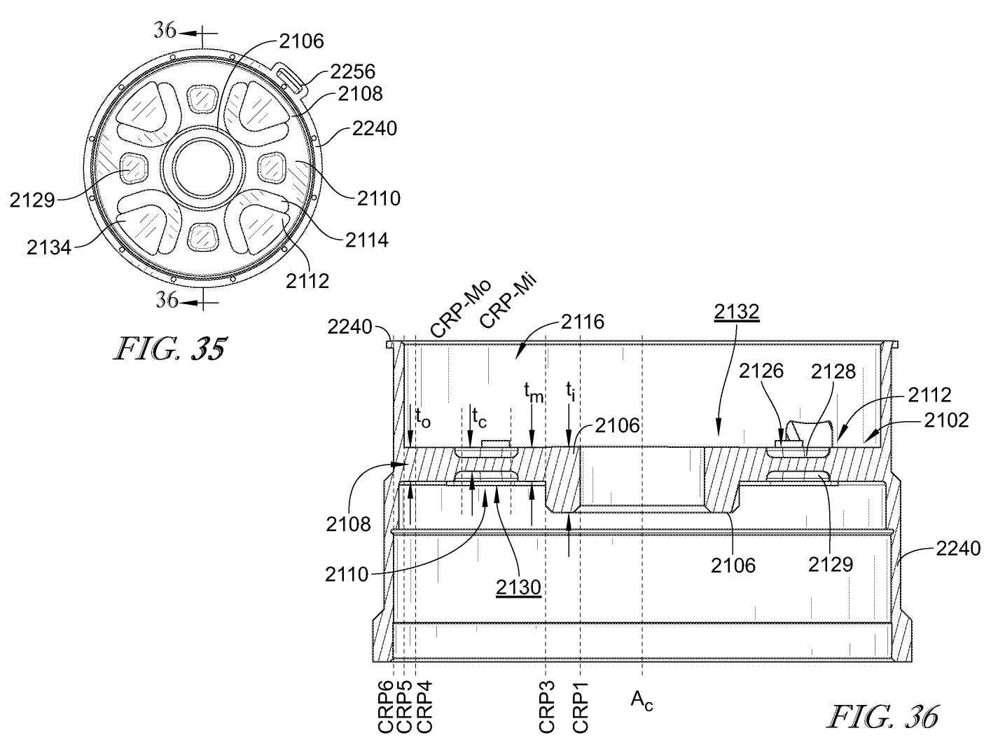

As shown in FIG. 36, the beams 2110 can have a main thickness (tₘ) that is substantially uniform and a sunken portion 2126 can have a recessed thickness (tᵣ) that is thinner than the main thickness. In an example, the recessed thickness (tᵣ) can be about 32% to about 49% of the main thickness (tₘ). The shape of the sunken portion 2126 can be any shape that provides structural or deformation properties required for a specified actuator. For example, the shape of the sunken portion 2126 can be substantially trapezoidal or that of a different polygon. The sunken portion 2126 can include equally shaped and sunken portions on opposing sides of the beams 2110. The outer rim 2108 can have a thickness that is the same as the main thickness of the beams 2110. For example, the beams 2110 can be formed together with the outer rim 2108 and radially extend inward to the inner hub 2106 with substantially flat opposing surfaces. Together, the outer rim 2108 and the beams 2110 define a first surface 2132 and an opposite second surface 2130 of the flexure element 2102. As shown in the figures, the inner hub 2106 can have a thickness (tᵢ) greater than the main thickness (tₘ) of the beams 2110. The inner hub 2106 can be substantially flush with the first surface 2132 of the flexure element 2102 and protrude outward from the second surface 2130. The inner hub 2106 is configured with rigidity to distribute loads evenly to the beams 2110.

As shown in FIGS. 32-34, the outer framing portions 2112 can be recessed from the first surface 2132 of the beams 2110 and have a thickness (t_{of}) that is substantially thinner than the main thickness (tₘ) of the beams 2110. The outer framing portions 2112 can be arranged to have a tab surface 2134 that is substantially flush with the second surface 2130 of the inner hub 2106 and beams 2110 of the flexure element 2102. In some embodiments, the tab surface 2134 of the outer framing portions may be offset with respect to the second surface 2130. In some embodiments, each outer framing portion 2112 may further include a board mount 2136 that is adjacent to the outer rim 2108 with a thickness (t_{bm}) that is substantially the same as the outer rim 2108 or greater than the thickness of the outer rim 2108. In some embodiments, the thickness of the board mount 2136 may be less than the thickness of the outer rim 2108. The board mount 2136 can include an aperture configured to receive a fastener from the output side 2252 of the flexure element 2102 without protruding through the tab surface 2134. The second surface 2130 can be substantially flat and configured to receive or mount the protective shield 2260.

### c.Fourth Embodiment

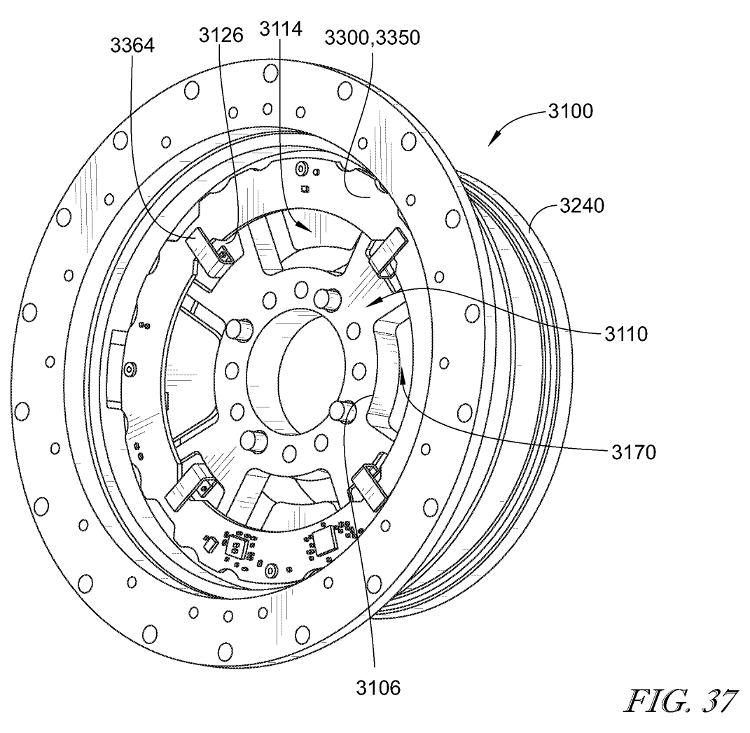

Shown in FIGS. 37-40 as a fourth embodiment, torque cell 3100 excludes a housing and can be coupled to a separate actuator housing 3240 by fasteners 3196 or other coupling means. For sake of brevity, the above disclosure in connection with flexure element 102 will not be repeated below, but it should be understood that across embodiments like numbers represent like structures. In this embodiment, an outer mounting portion 3192 extends radially from the outer rim 3108 of the flexure element 3102. The outer mounting portion 3192 is configured with mounting apertures 3194 to receive fasteners 3196 to couple the flexure element 3102 to the housing 3240. In this embodiment, the inner hub 3106 is substantially flush with a first surface 3132 of the radial beams 3110 and protrudes from the opposite second surface 3130 to receive a protective shield 3260. The separation portions 3170 also include board mounting structures 3136 positioned adjacent to the outer rim 3108 and protrude from the first surface 3132 to secure an extent of the sensor assembly 3300.

### d.Fifth Embodiment

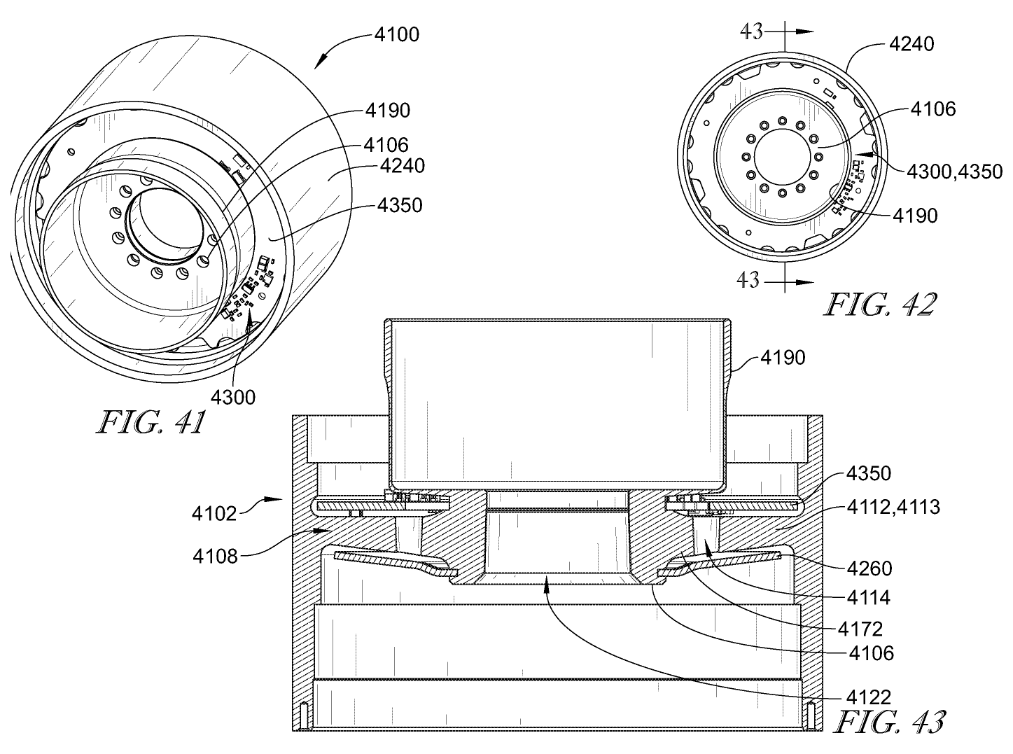

Shown in FIGS. 41-43, a fifth embodiment of torque cell 4100 is substantially similar to the first embodiment 100 and includes a flexible externally-toothed gear 4190 of a hollow-type strain wave gear that is integrally formed with the inner hub 4106. For sake of brevity, the above disclosure in connection with flexure element 102 will not be repeated below, but it should be understood that across embodiments like numbers represent like structures. In this embodiment, the flexure element 4102 is substantially the same as the first embodiment flexure element 102 and is integrated with housing 4240. The torque cell 4100 additionally includes a flexible externally-toothed gear 4190 formed from a single piece of material with the flexure element 4102. The integrated flexible externally-toothed gear 4190 may further increase torque measurement accuracy, reduce the assembly time, reduce the number of separate components, and increase the durability of the actuator.

### e.Sixth Embodiment

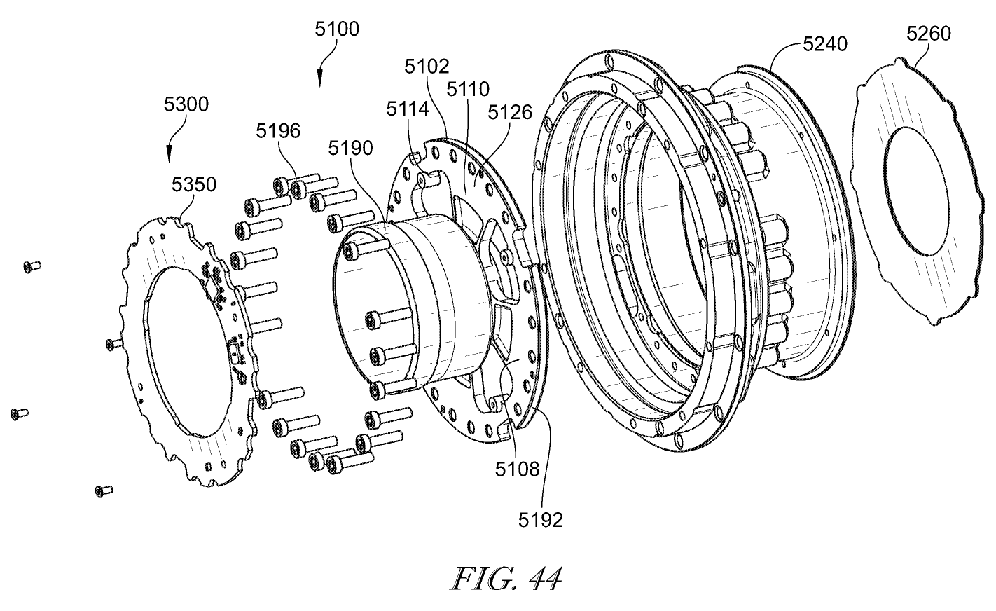

Shown in FIGS. 44-47, a sixth embodiment of torque cell 5100 is substantially similar to the fourth embodiment 3100 and includes a flexible externally-toothed gear 5190 of a hollow-type strain wave gear that is integrally formed with the inner hub 5106. For sake of brevity, the above disclosure in connection with flexure element 102 will not be repeated below, but it should be understood that across embodiments like numbers represent like structures. In this embodiment, the flexure element 5102 has substantially the same features as the fourth embodiment flexure element 3102. The torque cell 5100 excludes a housing and can be coupled to a separate housing 5240 of an actuator by other means and additionally includes a flexible externally-toothed gear 5190 formed from a single piece of material with the flexure element 5102. The integrated flexible externally-toothed gear 5190 may further increase torque measurement accuracy, reduce the assembly time, reduce the number of separate components, and increase the durability of the actuator.

It should be understood that other sensors and/or technology may be used instead of or in combination with the sensor assemblies discussed above. Other strain gauge technology that may be used includes: (i) mems-based strain gauges, (ii) nanocomposite strain gauges, (iii) thin-film or thick-film strain gauges (e.g., C4A Series or EA Series from Vishay Precision Group, RF9 Series or Y Series from Hottinger Brüel & Kjær, KFG Series or KFR Series from Kyowa Electronic Instruments, TFSG Series from BCM Sensor Technologies, SGT Series or KFH Series from Omega Engineering, ELF Series or EPL Series from Meggitt Sensing Systems, or any other known manufacture), (iv) inductive strain gauges, (v) capacitive strain gauges, (vi) piezoelectric strain gauges, (vii) optical fiber strain gauges, (viii) semiconductor strain gauges, and/or (ix) a hybrid or combination thereof.

While the disclosure shows illustrative embodiments of a reaction-type torque cell of an actuator of a robot (in particular, a humanoid robot), it should be understood that embodiments are designed to be examples of the principles of the disclosed assemblies, methods and systems, and are not intended to limit the broad aspects of the disclosed concepts to the embodiments illustrated. As will be realized, the disclosed torque cell, and its functionality and methods of operation, are capable of other and different configurations and several details are capable of being modified all without departing from the scope of the disclosed methods and systems. For example, one or more of the disclosed embodiments, in part or whole, may be combined consistent with other embodiments disclosed herein. For example, any flexure element may either be integrally formed with the actuator housing or may not be integrally formed with the actuator housing. Additionally and/or alternatively, an extent of the gearing (e.g., flexcup) may or may not be integrally formed with any flexure element disclosed herein. As such, one or more components or elements in the Figures may be selectively omitted and/or combined consistent with the disclosed embodiments, assemblies, methods and systems. Additionally, one or more steps from the arrangement of components may be omitted or performed in a different order. Accordingly, the drawings, diagrams, and detailed description are to be regarded as illustrative in nature, not restrictive or limiting.

While the above described torque cell of an actuator is designed for use with a general-purpose humanoid robot, it should be understood that its assemblies, components, and/or capabilities may be used with other robots. Examples of other robots include: articulated robot (e.g., an arm having two, six, or ten degrees of freedom, etc.), a cartesian robot (e.g., rectilinear or gantry robots, robots having three prismatic joints, etc.), selective compliance assembly robot arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servo motors and stepper motors), actuators, biasing members, encoders, housing, or any other component known in the art that is used in connection with robot systems. Likewise, the robot system may omit one or more sensors (e.g., cameras, temperature, pressure, force, inductive or capacitive touch), motors (e.g., servo motors and stepper motors), actuators, biasing members, encoders, housing, or any other component known in the art that is used in connection with robot systems.

In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. It should also be understood that substantially utilized herein means a deviation that is less than 15% and preferably less than 5%. It should also be understood that other configuration or arrangements of the above described components is contemplated by this Application.

In this Application, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference.

What is claimed is:

1. A printed circuit board for an actuator of a humanoid robot, the printed circuit board comprising:
a board assembly comprising:
a plurality of board layers arranged in a stacked configuration, the plurality of board layers comprising a top layer; and
a central aperture extending through the plurality of board layers;
a plurality of sets of wiring contacts positioned on the top layer of the board assembly, wherein each set of wiring contacts in the plurality of sets of wiring contacts is (i) positioned to align with a respective strain gauge of a plurality of strain gauges to be affixed to the actuator of the humanoid robot and (ii) configured to receive electrical signals from the respective strain gauge, wherein the plurality of sets of wiring contacts comprises:
a first set of wiring contacts;
a second set of wiring contacts positioned 90 degrees from the first set of wiring contacts about the central aperture of the board assembly;
a third set of wiring contacts positioned 90 degrees from the second set of wiring contacts about the central aperture of the board assembly, wherein the third set of wiring contacts is positioned opposite the first set of wiring contacts; and
a fourth set of wiring contacts positioned 90 degrees from the third set of wiring contacts about the central aperture of the board assembly, wherein the fourth set of wiring contacts is positioned opposite the second set of wiring contacts; and
a measurement circuit formed on one or more layers of the plurality of board layers of the board assembly, wherein the measurement circuit is (i) electrically coupled to each set of wiring contacts in the plurality of sets of wiring contacts and (ii) configured to receive and process the electrical signals from the plurality of strain gauges to determine a torque measurement associated with the actuator of the humanoid robot.

2. The printed circuit board of claim 1, further comprising a respective conductive coupler corresponding to each set of wiring contacts, each conductive coupler configured to couple the set of wiring contacts to a corresponding set of leads of a respective strain gauge of the plurality of strain gauges.

3. The printed circuit board of claim 2, wherein each conductive coupler comprises a flexible ribbon cable.

4. The printed circuit board of claim 1, wherein each strain gauge comprises a first resistance gauge element and a second resistance gauge element, and wherein each set of wiring contacts comprises (i) a first pair of wiring contacts configured to receive signals from the first resistance gauge element of a respective strain gauge of the plurality of strain gauges and (ii) a second pair of wiring contacts configured to receive signals from the second resistance gauge element of the respective strain gauge.

5. The printed circuit board of claim 1, wherein:
(a) the first set and the third set of wiring contacts are positioned along a first axis corresponding to a centerline of a first beam within a flexure element of the actuator, wherein:
(i) a first pair of wiring contacts of the first set of wiring contacts is positioned on a first side of the first axis;
(ii) a second pair of wiring contacts of the first set of wiring contacts is positioned on a second side of the first axis;
(iii) a first pair of wiring contacts of the third set of wiring contacts is positioned on the second side of the first axis; and
(iv) a second pair of wiring contacts of the third set of wiring contacts is positioned on the first side of the first axis; and
(b) the second set and the fourth set of wiring contacts are positioned along a second axis corresponding to a centerline of a second beam within the flexure element of the actuator, wherein:
(i) a first pair of wiring contacts of the second set of wiring contacts is positioned on a first side of the second axis;
(ii) a second pair of wiring contacts of the second set of wiring contacts is positioned on a second side of the second axis;
(iii) a first pair of wiring contacts of the fourth set of wiring contacts is positioned on the second side of the second axis; and
(iv) a second pair of wiring contacts of the fourth set of wiring contacts is positioned on the first side of the second axis.

6. The printed circuit board of claim 5, wherein the measurement circuit comprises:
a first wiring pair connecting the first set of wiring contacts to the second set of wiring contacts;
a second wiring pair connecting the third set of wiring contacts to the fourth set of wiring contacts;
a third wiring pair connecting the second set of wiring contacts to the third set of wiring contacts; and
a fourth wiring pair connecting a center tap of each wire of the third wiring pair to a first signal output connection and a second signal output connection.

7. The printed circuit board of claim 6, wherein at least the first, second, and third wiring pairs are arranged parallel to each other in a substantially arcuate path around the central aperture to reduce an effect of magnetic forces on the measurement circuit.

8. The printed circuit board of claim 6, further comprising:
a voltage source connection positioned on the board assembly; and
a ground connection positioned on the board assembly,
wherein the first signal output connection and the second signal output connection are positioned on the board assembly, and
wherein the measurement circuit further comprises:
a fifth wiring pair connecting the first set of wiring contacts to the voltage source connection; and
a sixth wiring pair connecting the fourth set of wiring contacts to the ground connection.

9. The printed circuit board of claim 8, wherein the voltage source connection, the ground connection, the first signal output connection, and the second signal output connection are positioned on the top layer of the board assembly.

10. The printed circuit board of claim 8, wherein the board assembly comprises one or more vias connecting wiring paths between layers of the board assembly, and wherein the fourth wiring pair is positioned on a different layer of the board assembly from the first, second, or third wiring pairs.

11. The printed circuit board of claim 1, wherein the board assembly comprises one or more notches positioned along an edge of the board assembly, the one or more notches configured to align the plurality of sets of wiring contacts with respective leads on the plurality of strain gauges when the printed circuit board is coupled to the actuator of the humanoid robot.

12. The printed circuit board of claim 11, wherein the one or more notches comprise one or more interior notches positioned on an edge of the central aperture.

13. The printed circuit board of claim 1, further comprising a processor positioned on the top layer of the board assembly and electrically coupled to the measurement circuit, wherein the processor is configured to determine, based on the electrical signals from the plurality of strain gauges, a torque measurement associated with the actuator of the humanoid robot.

14. A printed circuit board for an actuator of a humanoid robot, the printed circuit board comprising:
a board assembly comprising:
a top board layer;
a bottom board layer comprising at least one connection interface for an electronic component;
one or more intermediate board layers positioned between the top and bottom board layers, wherein the top board layer, the bottom board layer, and the one or more intermediate board layers are arranged in a stacked configuration; and
a central aperture extending through the stacked configuration of board layers, the central aperture configured to align with an open bore of the actuator;
two or more sets of wiring contacts positioned on the top board layer, wherein each set of wiring contacts is positioned on the top board layer to align with, and receive electrical signals from, a respective strain gauge to be affixed to the actuator of the humanoid robot; and
a measurement circuit configured to receive and process the electrical signals from the respective strain gauges to determine a torque measurement associated with the actuator of the humanoid robot, the measurement circuit comprising a plurality of wiring pairs, wherein each wiring pair in the plurality of wiring pairs (i) is positioned on at least one of the one or more intermediate board layers, and (ii) connects pairs of wiring contacts in two different sets of wiring contacts.

15. The printed circuit board of claim 14, wherein each set of wiring contacts comprises a first pair of wiring contacts and a second pair of wiring contacts, wherein the first pair of wiring contacts is configured to receive a first electrical signal indicative of a first resistance change and the second pair of wiring contacts is configured to receive a second electrical signal indicative of a second resistance change.

16. The printed circuit board of claim 15, wherein the first resistance change corresponds to a tensile strain detected by a first resistance gauge element of the respective strain gauge and the second resistance change corresponds to a compressive strain detected by a second resistance gauge element of the respective strain gauge.

17. The printed circuit board of claim 16, wherein the measurement circuit is configured to determine the torque measurement based on a difference between the first electrical signal and the second electrical signal.

18. The printed circuit board of claim 16, wherein the measurement circuit comprises a Wheatstone bridge arrangement, wherein the first pairs of wiring contacts of the sets of wiring contacts are coupled in opposing legs of the Wheatstone bridge arrangement and wherein the second pairs of wiring contacts of the sets of wiring contacts are coupled in opposing legs of the Wheatstone bridge arrangement.

19. The printed circuit board of claim 18, wherein the Wheatstone bridge arrangement is configured to produce an output voltage proportional to an applied torque based on the first and second electrical signals received from the respective strain gauges.

20. The printed circuit board of claim 14, wherein the measurement circuit further comprises an amplifier configured to amplify the electrical signals from the respective strain gauges.

21. The printed circuit board of claim 14, wherein the plurality of wiring pairs comprises three wiring pairs positioned in a first intermediate board layer of the one or more intermediate board layers, and wherein the measurement circuit further comprises a fourth wiring pair positioned in a second intermediate board layer of the one or more intermediate board layers, the fourth wiring pair connecting one of the sets of wiring contacts to a ground connection.

22. The printed circuit board of claim 1, wherein:
the plurality of board layers further comprises an intermediate layer and a bottom layer, the intermediate layer positioned between the top layer and the bottom layer; and
the measurement circuit comprises at least three wiring pairs, each of the at least three wiring pairs (a) connecting wiring contacts of two different sets of the plurality of sets of wiring contacts, (b) positioned on the intermediate layer, and (c) arranged parallel to others of the at least three wiring pairs in a substantially arcuate path around the central aperture.

23. The printed circuit board of claim 13, wherein the board assembly further comprises one or more notches positioned along an edge of the board assembly, the one or more notches configured to align the plurality of sets of wiring contacts with respective leads on the plurality of strain gauges when the printed circuit board is coupled to the actuator of the humanoid robot.

24. The printed circuit board of claim 14, wherein the two or more sets of wiring contacts comprise four sets of wiring contacts arranged at 90-degree intervals about the central aperture of the board assembly, the four sets of wiring contacts comprising a first set, a second set positioned opposite the first set across the central aperture, a third set positioned 90 degrees from the first set about the central aperture, and a fourth set positioned opposite the third set across the central aperture.
